(19) United States
(12) Patent Application Publication
(10) Pub. No.: US 2020/0199011 A1
(43) Pub. Date: Jun. 25, 2020

(54) CHEMICALLY RESISTANT BORON- AND ALKALI-FREE GLASSES

(71) Applicant: Schott AG, Mainz (DE)

(72) Inventors: Ulrich Fotheringham, Wiesbaden (DE); Peter Naß, Mainz (DE); Stephan Tratzky, Neustadt/Wn. (DE); Simone Monika Ritter, Mainz (DE); Rainer Eichholz, Frankfurt am Main (DE); Christoph Berndhäuser, Nieder-Olm (DE)

(73) Assignee: Schott AG, Mainz (DE)

(21) Appl. No.: 16/722,527

(22) Filed: Dec. 20, 2019

(30) Foreign Application Priority Data
Dec. 21, 2018 (DE) 10 2018 133 413.3

(51) Int. Cl. C03C 3/085; C03C 4/20

(52) U.S. Cl. CPC C03C 3/085; C03C 4/20; C03C 2201/42; C03C 2201/32; C03C 2201/54

(57) ABSTRACT

A glass includes a composition which is characterized by the following constituent phases of the glass: 20-80 mol % silicon dioxide; 0-40 mol % wollastonite; 0-30 mol % cordierite; 0-40 mol % anorthite; 0-40 mol % strontium-feldspar; 0-20 mol % celsian; 0-40 mol % hardystonite; 0-10 mol % titanite; and 0-15 mol % gittinsite. Where the composition is specified in mol % relative to oxides, the glass contains less than 11.5 mol % Al₂O₃ and less than 5000 ppm (molar, relative to the oxides) of each of B₂O₃, Li₂O, Na₂O, K₂O, Rb₂O and Cs₂O. A calculated value for the removal rate according to ISO 695 is not more than 81.9 mg/(dm² 3 h) and a calculated value for the removal rate in acid according to DIN12116 is less than 3.5 mg(dm² 6 h).

### CROSS REFERENCE TO RELATED APPLICATIONS

This application claims priority to German Application No. 10 2018 133 413.3 filed Dec. 21, 2018, the contents of which are incorporated herein by reference.

### BACKGROUND OF THE INVENTION

### 1. Field of the Invention

The present invention relates to glasses and glass products with very good resistance to alkaline solutions and acids, hydrolytic resistance and a desired coefficient of thermal expansion. Methods for producing such glasses and uses thereof are also provided according to the present invention. The glasses may be used, for example, in the area of glass tubing, particularly pharmaceutical tubing and lamp tubes as well as for fiber-reinforced plastics. The present invention further relates to a pharmaceutical packaging system with a chemically resistant glass, which is particularly suitable for use as primary packaging material in the pharmaceutical industry.

### 2. Description of the Related Art

Chemically resistant glasses are known from the prior art. Many regulations and standards have been established for the characterization of chemical resistance, particularly ISO 695 for resistance to alkaline solutions, ISO 719/720 for hydrolytic resistance and ISO 1776 and DIN 12116 for resistance to acids.

EP0510544, U.S. Pat. Nos. 9,061,938, 9,670,087, JPH05155638, U.S. Pat. No. 9,586,854, DE1816391, U.S. Pat. No. 4,012,263, EP0048120, WO2013130695, WO2012103194, WO0242233, WO2015009483, and DE102017102900 describe chemically resistant glasses. However, there is a lack of glasses which combine the desired thermal expansion properties with a comprehensive chemical resistance which also includes resistance to acids.

What is needed in the art are glasses which combine advantageous thermal expansion properties with a comprehensive chemical resistance which also includes resistance to acids. The glasses should also be producible in modern tube drawing manufacturing processes, flat glass or fiber drawing processes.

### SUMMARY OF THE INVENTION

In some exemplary embodiments provided according to the present invention, a glass includes a composition which is characterized by the following constituent phases of the glass: 20-80 mol % silicon dioxide; 0-40 mol % wollastonite; 0-30 mol % cordierite; 0-40 mol % anorthite; 0-40 mol % strontium-feldspar; 0-20 mol % celsian; 0-40 mol % hardystonite; 0-10 mol % titanite; and 0-15 mol % gittinsite. Where the composition is specified in mol % relative to oxides, the glass contains less than 11.5 mol % A1203 and less than 5000 ppm (molar, relative to the oxides) of each of B₂O₃, Li₂O, Na₂O, K₂O, Rb₂O and Cs₂O. A calculated value for the removal rate according to ISO 695 is not more than 81.9 mg/(dm² 3 h) and a calculated value for the removal rate in acid according to DIN12116 is less than 3.5 mg(dm² 6 h).

### DETAILED DESCRIPTION OF THE INVENTION

Pharmaceutical packaging systems, such as those used for primary packaging material, must satisfy stringent requirements. In particular, a high chemical resistance is important; that is to say, a very good resistance to alkaline solutions and acids and hydrolytic resistance. Generally, a certain coefficient of thermal expansion is also desirable.

The glasses used for this should further be non-delaminating; that is to say that layers which might contaminate the packaged pharmaceutical product must not peel off from the glass during use. One cause of delamination is the evaporation of alkali borates or boron- and alkali hydroxides during hot forming of pharmaceutical containers. This can be categorically prevented with the boron-free and alkali-free glasses provided according to the present invention.

The previously described problems can be at least partially solved with a specifically selected combination of stoichiometric glasses; that is to say, glasses which also exist as crystals in the same stoichiometry and whose property can be assumed to be very similar because of the generally identical topology of the components for both the glass and the crystal—as tested with NMR measurements and the like according to many documented examples. For this purpose, such stoichiometric glasses whose mixture makes a behavior conducive to solving the previously described problems are selected. In this application, such stoichiometric glasses are also referred to as “constituent phases”.

The idea of describing glasses according to the constituent phases attributable to them is not new. Conclusions can be drawn about the chemical structure of a glass by specifying the base glasses (see Conradt R: “Chemical structure, medium range order, and crystalline reference state of multicomponent oxide liquids and glasses”, in Journal of Non-Crystalline Solids, Volumes 345-346,15 October 2004, Pages 16-23).

The present invention relates to a glass having a composition which is characterized by the following constituent phases of the glass; at the same time, this base system defined by the constituent phases is limited according to the present invention by the composition ranges listed:

TABLE 1

| Constituent phase | Min (mol %) | Max (mol %) |
|---|---|---|
| Silicon dioxide | 20 | 80 |
| Wollastonite | 0 | 40 |
| Cordierite | 0 | 30 |
| Anorthite | 0 | 40 |
| Strontium-feldspar | 0 | 40 |
| Celsian | 0 | 20 |
| Hardystonite | 0 | 40 |
| Titanite | 0 | 10 |
| Gittinsite | 0 | 15 |

The base systems refer explicitly to the constituent phases listed for each, and not to the simple oxides. Notwithstanding the above, given the nature of the problem as stated and the close relationship between the aluminum content and the acid resistance according to DIN 12116, the glasses provided according to the present invention contain less than 11.5 mol % Al₂O₃.

The glass provided according to the present invention must also satisfy further conditions which are in relationships with the composition of constituent phases and the composition of simple oxides that are expressed in formulas and will be described further herein.

Since both types of relationships—those with the composition specified in constituent phases and those with the composition specified in simple oxides—are used side by side, conversion matrices are first presented for converting in both directions between the two composition specifications.

Conversion from the Composition of Constituent Phases to the Composition of Simple Oxides and Vice Versa

For the purpose of conversion, the composition of constituent phases is shown in a standardized form, to the following effect:

TABLE 2

| | Formula (standardized to |
|---|---|
| Constituent phase | a simple oxide) |
| Silicon dioxide | SiO2 |
| Wollastonite | (CaO•SiO2)/2 |
| Cordierite | (2MgO•2Al2O3•5SiO2)/9 |
| Anorthite | (CaO•Al2O3•2SiO2)/4 |
| Strontium-feldspar | (SrO•Al2O3•2SiO2)/4 |
| Celsian | (BaO•Al2O3•2SiO2)/4 |
| Hardystonite | (2CaO•ZnO•2SiO2)/5 |
| Titanite | (CaO•TiO2•SiO2)/3 |
| Gittinsite | (CaO•ZrO2•2SiO2)/4 |

The conversion of these compositions to a composition specification in mol % relative to the simple oxides of Table 3 is carried out with the aid of the matrix shown in Table 4. The composition specification in mol % relating to the base glasses is multiplied as a column vector with the matrix from the right.

TABLE 3

| # | Oxide |
|---|---|
| 1. | SiO₂ |
| 2. | TiO₂ |
| 3. | ZrO₂ |
| 4. | Al₂O₃ |
| 5. | ZnO |
| 6. | MgO |
| 7. | CaO |
| 8. | SrO |
| 9. | BaO |

TABLE 4
$( \begin{matrix}1 & 1 / 2 & 5 / 9 & 2 / 4 & 2 / 4 & 2 / 4 & 2 / 5 & 1 / 3 & 2 / 4 \\ 0 & 0 & 0 & 0 & 0 & 0 & 0 & 1 / 3 & 0 \\ 0 & 0 & 0 & 0 & 0 & 0 & 0 & 0 & 1 / 4 \\ 0 & 0 & 2 / 9 & 1 / 4 & 1 / 4 & 1 / 4 & 0 & 0 & 0 \\ 0 & 0 & 0 & 0 & 0 & 0 & 1 / 5 & 0 & 0 \\ 0 & 0 & 2 / 9 & 0 & 0 & 0 & 0 & 0 & 0 \\ 0 & 1 / 2 & 0 & 1 / 4 & 0 & 0 & 2 / 5 & 1 / 3 & 1 / 4 \\ 0 & 0 & 0 & 0 & 1 / 4 & 0 & 0 & 0 & 0 \\ 0 & 0 & 0 & 0 & 0 & 1 / 4 & 0 & 0 & 0\end{matrix} ) \times ( \begin{matrix}{SiO}_{2} \\ ( CaO \cdot {SiO }_{2} ) / 2 \\ ( 2 MgO \cdot 2 {Al}_{2} {O}_{3} \cdot 5 {SiO}_{2} ) / 9 \\ ( CaO \cdot {Al}_{2} {O}_{3} \cdot 2 {SiO}_{2} ) / 4 \\ ( SrO \cdot {Al}_{2} {O}_{3} \cdot 2 {SiO}_{2} ) / 4 \\ ( BaO \cdot {Al}_{2} {O}_{3} \cdot 2 {SiO}_{2} ) / 4 \\ ( 2 CaO \cdot ZnO \cdot 2 {SiO}_{2} ) / 5 \\ ( CaO \cdot {TiO}_{2} \cdot {SiO}_{2} ) / 3 \\ ( CaO \cdot {ZrO}_{2} \cdot 2 {SiO}_{2} ) / 4\end{matrix} )$

The composition of the glass in mole percentages is obtained as the product of the multiplication of the column vector with the matrix.

Conversely, a composition in mole percentages can be transposed to a base glass composition simply by using the respective inverse matrix. In this case, only those base glass compositions which do not return negative values after the conversion are considered to fall within the scope of the present invention.

Significance of the Constituent Phases and Selection thereof

The composition is chosen within the limits described herein with a view to the phases that constitute the glass. The constituent phases of the glass as such are not present in the crystalline form in the glass product, but are amorphous. However, this does not mean that the constituent phases in the amorphous state have completely different components than in the crystalline state. As was noted earlier, the topology of the components is comparable, that is to say, for example, the coordination of the participating cations with surrounding oxygen atoms or the interatomic distance established as a result of the coordination and the strength of the bond between said cations and surrounding oxygen atoms. Therefore, the many properties of the glass provided according to the present invention can be described effectively in terms of the constituent phases, particularly in order to represent the inventive activity and the problems that are overcome with embodiments provided according to the present invention (see Conradt R., loc. cit. on this point). At the same time, the glass can be produced not only by using the corresponding crystals, but also by using the usual glass raw materials, providing that only the stoichiometric proportions enable the formation of the corresponding components of the base glasses.

The phases are selected with a view to chemical resistance and the coefficient of thermal expansion. Further herein, calculation methods will be presented, describing how these parameters are calculated from a prescribed composition of constituent phases. These calculation methods are essential both for the selection of the constituent phases and for the precise composition of a glass provided according to the present invention consisting of said constituent phases.

During the search for suitable calculation methods, it was surprisingly found that simple formulas can be found for the properties in question, and from which characteristic figures or approximate values can be calculated for these properties, and which in turn allow rapid classification of glass compositions either favorable or unfavorable with respect to solving the previously described problems.

The coefficient of thermal expansion as a characteristic figure can be derived from the average bond strength, from which the value of the coefficient of thermal expansion can be calculated to a very close approximation with the aid of a semi-empirical formula. According to the present invention, the coefficient of thermal expansion may be between 3 and 6 ppm/K, such as between 3.5 and 5.5 ppm/K or between 4.0 and 5.5 ppm/K. This refers to the calculation value for the CTE determined according to the formula (18) provided further herein.

Both the hydrolytic resistance according to ISO 719/720 and resistance to alkaline solutions according to ISO 695 essentially include a resistance of the glass to attack by hydroxyl ions. In this context, in the case of ISO 695 the concentration of hydroxyl ions in the alkaline solution is defined by using a buffer solution containing 0.5 mol/l sodium hydroxide and 0.25 mol/l sodium carbonate. In the case of ISO 719/720, the glass is immersed in neutral water whose pH value is initially adjusted to 5.5 (tested with methyl red indicator solution) but which shifts into the alkaline range very quickly as the glass dissolves. A buffer solution is obtained from the weak acids (and acid anhydrides) contained in the glass, most notably silicic acid, and strong alkaline solutions (such as sodium hydroxide), whose pH is in the range from 9 to 10, see Susanne Fagerlund, Paul E k, Mikko Hupa and Leena Hupa: On determining chemical durability of glasses, Glass Technol.: Eur. J. Glass Sci. Technol. A, December 2010, 51 (6), 235-240. Decisive for the pH of a buffer solution are the pKa value(s) of the weak acid(s). The concentration of the hydroxyl ions is established by the pH value of the resulting buffer solution, wherein this value both depends on the glass type and increases as the dissolution proceeds. The dissolution initiated by these hydroxyl ions then proceeds according to the same mechanism as for the measurement of resistance to alkaline solutions.

In order to make a glass resistant to both alkaline solutions and hydrolysis, the first step is therefore to fix the removal rate in the test according to ISO 695 at a low value. This removal rate can be derived from two characteristic figures, firstly a cross-linking number obtained from topological considerations (the larger the number, the lower the removal rate) and secondly the so-called “optical basicity” of the glass (here too: the larger this number is, the lower the removal rate is). From these, a very good approximate value for the removal rate according to ISO 695 can be obtained.

Secondly, a limit must be set for the pH value that is obtained during a test according to ISO 719/720 and the dissolution of a certain quantity of glass in the aqueous test solution that takes place during the test. The higher this pH value rises during the test, the greater the risk becomes of initiating a positive feedback effect: as the pH level rises, so too does the removal rate, as more material is removed in the aqueous solution, this again raises the pH value, and so on.

Chemically resistant glasses (hydrolytic class HGB I according to ISO 719 or hydrolytic class HGA I according to ISO 720) typically lose some material during the test, resulting in 100 μmol or less glass in the aqueous solution, wherein in general the smaller the quantity removed, the less congruent this quantity is.

Since a comparison of glasses must be based on fixed conditions; as used herein, the reference pH is the pH which exists following a dissolution of 50 μmol glass accepted as congruent in neutral water.

According to the present invention, exemplary glasses are those for which this pH is lower than 9.15, such as lower than 9.10, lower than 9.05, lower than 9.00, or lower than 8.95. This refers to the pH value calculated on the basis of equation system (1).

According to the present invention, the removal rate according to ISO 695 is not more than 81.9 mg/(dm² 3 h), such as not more than 81.8 mg/(dm² 3 h), not more than 81.7 mg/(dm² 3 h), not more than 81.6 mg/(dm² 3 h), not more than 81.5 mg/(dm² 3 h), not more than 81 mg/(dm² 3 h), not more than 80.5 mg/(dm² 3 h), not more than 80.25 mg/(dm² 3 h), not more than 80 mg/(dm² 3 h), not more than 79 mg/(dm² 3 h), not more than 78 mg/(dm² 3 h), not more than 77 mg/(dm² 3 h), not more than 76 mg/(dm² 3 h), or not more than 75 mg/(dm² 3 h). This refers to the removal rate calculated on the basis of formula (2).

Even the first value listed above is already more than half a class width below the boundary between the alkaline solution classes 2 and 3 according to ISO 695. This separation is chosen deliberately to be large enough to leave a large safety distance from class 3 even in the event of possible tolerances in the predictive accuracy of formula (2).

An acid attack with highly concentrated hydrochloric acid in accordance with the conditions defined in DIN12116 includes penetration of the glass surface by hydronium ions, which results in softening of the glass (also and particularly in the electrostatic sense, since water has very high permeability and consequently reduces the Coulomb correlation considerably) and the formation of an electrical double layer with the “positive pole” in the glass surface (positively charged hydronium ions) and the “negative pole” in the acid (chloride ions). This causes the glass cations to diffuse out and to be replaced by additional hydronium ions conversely diffusing in, which then leads to the dissolution of the network and the resulting loss of material in proportion to the number of these hydronium ions.

The removal rate in the acid resistance test may be determined with good approximation using the formulas (15, 16) presented further herein.

Regarding the calculated value for the removal rate in acid according to DIN121 16, it is required that said value must be <3.5 mg(dm² 6 h), such as <3 mg(dm² 6 h), <2.5 mg(dm² 6 h), <2.4 mg(dm² 6 h), <2.3 mg(dm² 6 h), <2 mg(dm² 6 h), <1.8 mg(dm² 6 h), <1.5 mg(dm² 6 h), <1.4 mg(dm² 6 h), <1.3 mg(dm² 6 h), or <1.1 mg(dm² 6 h).

In the next section, the calculation methods will be presented in detail.

### Calculation of pH Value in the Aqueous Solution in the Test of Hydrolytic Resistance

The calculation of the pH value in aqueous solution is based on the composition specification in simple oxides. In the diluted solution of the glass constituents, the corresponding cations are converted into the most highly oxidized hydroxides, see Table 5. The release of one H⁺ or OH⁻ from these hydroxides is described in each case by a corresponding pKa- or pKb value.

Regarding the pH value, reference is made to the value which is present following dissolution of 50 μmol in one liter of the aqueous solution after cooling to room temperature (25° C.).

TABLE 5

| | Oxide or | Acid or | | |
|---|---|---|---|---|
| # | anhydride | hydroxide | | |
| 1. | SiO₂ | H₄SiO₄ | H₄SiO₄ → H₃SiO₄⁻ + H⁺ | pKa = 9.7 ¹) |
| | | | H₃SiO₄⁻ → H₂SiO₄⁻² + H⁺ | pKa = 11.9 ¹) |
| 2. | ZrO₂ | Zr(OH)₄ | Zr(OH)₄ + H₂O → Zr(OH)₅⁻ + H⁺ | pKa = 5.99 ²) |
| | | | Zr(OH)₃⁺ + H₂O → Zr(OH)₄ + H⁺ | pKa = 4.6 ²) |
| 3. | Al₂O₃ | Al(OH)₃ | Al(OH)₃ + H₂O → Al(OH)₄⁻ + H⁺ | pKa = 12.3 ³) |
| | | | Al(OH)₂⁺ + H₂O → Al(OH)₃ + H⁺ | pKa = 5.7 ³) |
| 4. | ZnO | Zn(OH)₂ | Zn⁺² + H₂O → ZnOH⁺ + H⁺ | pKa = 9.05 ⁴) |
| | | | ZnOH⁺ + H₂O → Zn(OH)₂ + H⁺ | pKa = 9.75 ⁴) |
| | | | Zn(OH)₂ + H₂O → Zn(OH)₃⁻ + H⁺ | pKa = 10.1 ⁴) |
| | | | Zn(OH)₃⁻ + H₂O → Zn(OH)₄⁻ + H⁺ | pKa = 10.05 ⁴) |
| 5. | MgO | Mg(OH)₂ | Mg(OH)₂ → Mg(OH)⁺ + OH⁻ | pKb = −2 ⁵) |
| | | | Mg(OH)⁺ → Mg⁺⁺ + OH⁻ | pKb = 2.58 ⁶) |
| 6. | CaO | Ca(OH)₂ | Ca(OH)₂ → Ca(OH)⁺ + OH⁻ | pKb = −2 ⁵) |
| | | | Ca(OH)⁺ → Ca⁺⁺ + OH⁻ | pKb = 1.3 ⁷) |
| 7. | Na₂O | NaOH | NaOH → Na⁺ + OH⁻ | pKb = −0.77 ¹⁰) |
| 8. | K₂O | KOH | KOH → K⁺ + OH⁻ | pKb = −2 ¹¹) |
| 10. | SrO | Sr(OH)₂ | Sr(OH)₂ → Sr(OH)⁺ + OH⁻ | pKb = −2 ⁵⁾ |
| | | | Sr(OH)⁺ → Sr⁺⁺ + OH⁻ | pKb = 0.82 ¹²) |
| 11. | BaO | Ba(OH)₂ | Ba(OH)₂ → Ba(OH)⁺ + OH⁻ | pKb = −2 ⁵) |
| | | | Ba(OH)⁺ → Ba⁺⁺ + OH⁻ | pKb = 0.64 ¹³) |

¹) Pure Appl. Chem., 1969, Vol. 20, No. 2, pp. 133-236, number 176; value of the source denoted by “G40” there.
²) R.H. Byrne, Inorganic speciation of dissolved elements in seawater: the influence of pH on concentration ratios, Geochem. Trans. 3 (2) (2002) 11-16.
³) David W. Hendricks, Water Treatment Unit Processes: Physical and Chemical, CRC Taylor and Francis, Boca Raton, London, New York, 2006, p. 307; values of the sources denoted by “4”, “5”, “11”, “12” there.
⁴) Artur Krezel, Wolfgang Maret, The biological inorganic chemistry of zinc ions, Archives of Biochemistry and Biophysics (2016), pp 1-17.
⁵) As for barium hydroxide, see Pure Appl. Chem., 1969, Vol. 20, No. 2, pp. 133-236, number 12, it is assumed that M(OH)₂ → M(OH)⁺ + OH⁻ takes place to completion in all cases for all alkaline earths M; for this first dissociation, the highest pKb value appearing in this table is used, i.e., that of potassium hydroxide solution, as the pKb value.
⁶) Pure Appl. Chem., 1969, Vol. 20, No. 2, pp. 133-236, number 115; value of the source denoted by “S74” there.
⁷) Pure Appl. Chem., 1969, Vol. 20, No. 2, pp. 133-236, number 18; value of the source denoted by “D9” there.
¹⁰) Pure Appl. Chem., 1969, Vol. 20, No. 2, pp. 133-236, number 178; value of the source denoted by “G26” there.
¹¹) Pure Appl. Chem., 1969, Vol. 20, No. 2, pp. 133-236, number 164; value of the source denoted by “K2” there.
¹²) Pure Appl. Chem., 1969, Vol. 20, No. 2, pp. 133-236, number 180; value of the source denoted by “G26” there.
¹³) Pure Appl. Chem., 1969, Vol. 20, No. 2, pp. 133-236, number 12; value of the source denoted by “D7” there.

The pH value for a given composition is obtained by solving the equation system for the various concentrations (for pKa and pKb the values listed above are to be used):

Equation system (1)

[H₂SiO₄⁻⁻][H⁺]/[H₃SiO₄⁴]=10^{-pka}, 1.

[H₃SiO₄⁻][H⁺]/[H₄SiO₄]=10^{-pka}, 2.

[H₂SiO₄⁻⁻]+[H₃SiO₄⁻]+[H₄SiO₄]=50 (μmol/l)*c_{SiO2}, 3.

[Zr(OH)₅⁻][H⁺]/[Zr(OH)₄]=10^{-pka}, 4.

[Zr(OH)₄][H⁺]/[Zr(OH)₃⁺]=10^{-pka}, 5.

[Zr(OH)₅⁻]+[Zr(OH)₄]+[Zr(OH)3⁺]=50 (μmol/l)*c_{ZrO2}, 6.

[Al(OH)₄⁻][H⁺]/[Al(OH)₃]=10^{-pka} 7.

[Al(OH)₃][H⁺]/[Al(OH)₂⁺]=10^{-pka}, 8.

[Al(OH)₄⁻]+[Al(OH)₃]+[Al(OH)₂⁺]=50 (μmol/l)*2*c_{Al2O3}, 9.

[ZnOH⁺][H⁺]/[Zn⁺⁺]=10^{-pka}, 10.

[Zn(OH)₂][H⁺]/[ZnOH⁺]=10^{-pka}, 11.

[Zn(OH)₃⁻][H⁺]/[Zn(OH)₂]=10^{-pka}, 12.

[Zn(OH)₄⁻⁻][H⁺]/[Zn(OH)₃⁻]=10^{-pka}, 13.

[ZnOH⁺]+[Zn⁺⁺]+[Zn(OH)₂]+[Zn(OH)₃⁻]+[Zn(OH)₄⁻⁻]=50 (μmol/l)*c_{ZnO}, 14.

[MgOH⁺][OH⁻]/[Mg(OH)₂]=10^{-pkb} 15.

[Mg⁺⁺][OH⁻]/[MgOH⁺]=10^{-pkb}, 16.

[MgOH⁺]+[Mg(OH)₂]+[Mg⁺⁺]=50 (μmol/l)*c_{MgO}, 17.

[CaOH⁺][OH⁻]/[Ca(OH)₂]=10^{-pkb} 18.

[Ca⁺⁺][OH⁻]/[CaOH⁺]=10^{-pkb}, 19.

[CaOH⁺]+[Ca(OH)₂]+[Ca⁺⁺]=50 (μmol/l)*c_{CaO}, 20.

[SrOH⁺][OH⁻]/[Sr(OH)₂]=10^{-pkb} 21.

[SrOH⁺][OH⁻]/[SrOH⁺]=10^{-pkb}, 22.

[SrOH⁺]+[Sr(OH)₂]+[Sr⁺⁺]=50 (μmol/l)*c_{SrO}, 23.

[BaOH⁺][OH⁻]/[Ba(OH)₂]=10^{-pkb} 24.

[Ba⁺⁺][OH⁻]/[BaOH⁺]=10^{-pkb}, 25.

[BaOH⁺]+[Ba(OH)₂]+[Ba⁺⁺]=50 (μmol/l)*c_{BaO}, 26.

[Na⁺][OH⁻]/[NaOH]=10^{-pkb}, 27.

[Na⁺]+[NaOH]=50 (μmol/l)*2*c_{Na2O}, 28.

[K⁺][OH⁻]/[KOH]=10^{-pkb}, 29.

[K⁺]+[KOH]=50 (μmol/l)*2*c_{K2O}, 30.

[OH⁻][H⁺]=10⁻¹⁴, 31.

2*[H₂SiO₄⁻⁻]+[H₃SiO₄⁻]+[Zr(OH)₅⁻]+[Al(OH)₄⁻]+2*[Zn(OH)₄⁻⁻]+[Zn(OH)₃⁻]+[OH⁻]=[Zr(OH)₃⁺]+[Al(OH)₂⁺]+2*[Zn⁺⁺]+[ZnOH⁺]+2*[Ba⁺⁺]+[BaOH⁺]+2*[Sr⁺⁺]+[SrOH⁺]+2*[Ca⁺⁺]+[CaOH⁺]+2*[Mg⁺⁺]+[MgOH⁺]+[Na⁺]+[K⁺]+[H⁺] 32.

Equations 1-31 are conditions for equilibrium, and equation 32 is the electroneutrality condition.

The equation system can be solved uniquely with one of the usual mathematical codes such as for example MATHEMATICA by Wolfram Research Inc. MATHEMATICA supplies a list of solutions, although only one of these fulfils the essential additional condition according to which all concentrations must have positive values.

By definition, the pH value is the negative value of the common logarithm of [H⁺]. It is noted that at room temperature pKa+pKb=14.

The fraction of titanium oxide in the glass is not taken into account in this calculation of the pH value, because titanium oxide is insoluble in neutral or weakly basic aqueous solution.

### Calculation of Resistance to Alkaline Solutions According to ISO 695

On this point, exemplary embodiments provided according to the present invention are based on a surprisingly discovered relationship between a parameter constructed with the aid of topological considerations and the removal rate measured in the test according to ISO 695.

As presented in detail in DE 10 2014 119 594 A1, for example, the essence of topological considerations is the enumeration of the constraints imposed on the atoms by their bonding with neighboring atoms. These constraints relate on the one hand to the interatomic distance (“distance conditions”) and on the other hand to the bond angles (“angle conditions”). If an atom has r neighbors (r=coordination number), distance conditions attributable to this atom follow from the r distance conditions for these neighbors r/2 when the distance conditions are shared equally between both bonding partners. Further 2r-3 angle conditions which are attributable to this atom follow from the bonding angles between these neighbors and the atom in question at the vertex of the respective angle.

DE 10 2014 119 594 A1 describes a method which provides a weighting of all conditions with the individual bond strength and also an additional weighting of the angle conditions (only those originating from the oxygen-cation-oxygen angles; the conditions relating to the cation-oxygen-cation angles are ignored) with the degree of covalency of the respective bond when calculating the distance and angle conditions. In this context, the weighting factors are standardized by dividing each by the individual bond strength or the degree of covalency of the silicon-oxygen bond, thereby yielding a (rounded) number 1.333333333 (i.e. 4/3) for distance conditions and a (rounded) number 1.666666667 (i.e. 5/3) for angle conditions for each atom of quartz glass. As explained in DE 10 2014 119 594 A1, this matches the direct analysis of the topology of quartz glass if one simply counts all distance and angle conditions and ignores the angle conditions of the silicon-oxygen-silicon angles.

Accordingly, quartz glass has a number of “3” constraints per atom, which corresponds exactly to the number of degrees of freedom per atom. Thus, quartz glass should not have a number of degrees of freedom per atom (or in reality a very small number), which corresponds to the low cₚ-jump of quartz glass at the glass transition as measured by differential calorimetry, see R. Bruning, “On the glass transition in vitreous silica by differential thermal analysis measurements”, Journal of Non-Crystalline Solids 330 (2003) 13-22.

For other oxidic glasses, the values returned for the number of the distance and angle conditions per atom are generally lower than (rounded) 1.333333333 ( 4/3) and 1.666666667 ( 5/3) respectively. The differences are correspondingly the numbers of the distances and of the angular degrees of freedom per atom. The angular degrees of freedom may be differentiated further according to whether the associated angle conditions refer to angles which all lie in a plane (trigonal coordination) or not (tetrahedral or higher coordination). The latter are referred to here as 3D angle conditions; the difference from (rounded) 1.666666667 ( 4/3) is correspondingly referred to as 3D angular degrees of freedom.

Surprisingly, a correlation is found here between the number of the 3D angular degrees of freedom per atom and the removal rate r in the ISO 695 test, with which the position of a glass relative to the alkaline solution resistance classes can be estimated. This correlation, which is optimized specifically for applicability to glasses with high alkali content and has been tested for many glasses, is expressed by:

$$r = c \cdot ( \frac{M}{{M}_{{SiO}_{7}}} \cdot \frac{N}{{N}_{{SiO}_{2}}} ) \cdot ( {( 1 + f )}^{6} + {c}^{′} ) \cdot ( 0.9483333 - Λ ) \qquad ( 2 )$$

“c” is a constant with dimension mg/(dm² 3 h); the numeric value is 163.9. “f” is the number of the 3D angular degrees of freedom per atom. “c” is a dimensionless constant having value 1.8. The exponent “6” was found empirically. Λ is the optical basicity.

The factor N/N_{SiO2} is used for converting an atom group for which the abovementioned probability consideration was carried out to a mole. N is the number of atoms per mole. N_{SiO2} is the number of atoms per mole of quartz glass (specifically 3 N_{A}, N_{A} Avogadro's number) and is used to standardize this expression. This factor may be considered equivalent to a constant without significant error, and this constant may be incorporated in the prefactor “c” if one is only working within a narrowly defined glass family. The factor M/M_{SiO2} is used to convert the abovementioned atomic approach to a mass approach. M is the mass of a mole. M_{SiO2} is the mass of a mole of quartz glass (specifically 60.084 g) and is used to standardize this expression. This factor may also be considered equivalent to a constant without significant error, and this constant may be incorporated in the prefactor “c” if one is only working within a narrowly defined glass family.

As was noted previously, the correlation between removal rate and number of the 3D angular degrees of freedom was found empirically, but given that the kinetics of penetration of the glass by OH⁻ ions depends on the entropy of the glass, it appears plausible. The factor (0.9483333-Λ) is not associated with the kinetics of the process, but rather with the driving force of the acid-base reaction taking place as part of the dissolution of the glass in the alkaline solution.

Since the glasses provided according to the present invention contain a combination of the constituent phases described above, it is helpful for the calculation of the number of 3D angular degrees of freedom per atom to first specify them numerically for each constituent phase. These values are listed in the following Table 6.

TABLE 6

| | | | Number of | |
|---|---|---|---|---|
| | | | atoms per | Number of 3D |
| Constituent | | Molar | structural | angular degrees of |
| phase | Stoichiometry | mass/g | unit | freedom per atom |
| Silicon dioxide | SiO2 | 60.084 | 3 | 0 |
| Wollastonite | (CaO•SiO2)/2 | 58.0805 | 5/2 | 0.573505131 |
| Cordierite | (2MgO•2Al2O3•5SiO2)/9 | 64.9948 | 29/9 | 0.427525472 |
| Anorthite | (CaO•Al2O3•2SiO2)/4 | 69.5515 | 13/4 | 0.492665929 |
| Strontium- | (SrO•Al2O3•2SiO2)/4 | 81.437 | 13/4 | 0.501247171 |
| feldspar | | | | |
| Celsian | (BaO•Al2O3•2SiO2)/4 | 93.86375 | 13/4 | 0.508110849 |
| Hardystonite | (2CaO•ZnO•2SiO2)/5 | 62.7402 | 12/5 | 0.70417724 |
| Titanite | (CaO•TiO2•SiO2)/3 | 65.342 | 8/3 | 0.612867814 |
| Gittinsite | (CaO•ZrO2•2SiO2)/4 | 74.86675 | 11/4 | 0.459754564 |

The numeric values have been calculated according to the method specified in DE 10 2014 119 594 A1, wherein the number of the angular degrees of freedom has been calculated here as in DE 10 2014 119 594 A1 for all cations (whereas they were only calculated for boron and aluminum in that document); moreover, the degree of ionization of a cation-oxygen composition was not calculated according to formula (8) in DE 10 2014 119 594 A1, but according to formula (3) in Alberto Garcia, Marvon Cohen, First Principles Ionicity Scales, Phys. Rev. B 1993. For this, information about the coordination number of the respective cation is needed, for which the coordination number in the respective constituent phase according to Conradt, loc.cit. is used (if a cation occurs in multiple coordination numbers the value is averaged according to the proportions thereof in the various coordination numbers). The coordination numbers listed can be found in the literature, the quadruple coordination of silicon for SiO2 is assumed to be generally known; for Wollastonite: Mineralogical Society of America, Special Paper 1, pages 293-302, 1963, with respect to which source silicon is assumed to be tetracoordinate and calcium hexacoordinate; for cordierite: American Mineralogist, Volume 77, pages 407-411, 1992, with respect to which source silicon and aluminum are assumed to be tetracoordinate and magnesium hexacoordinate; for anorthite: American Mineralogist 58 (1973), 495-499, with respect to which source silicon and aluminum are assumed to be tetracoordinate and calcium heptacoordinate; for strontium-feldspar: American Mineralogist, Volume 60, pages 111-119, 1975, American Mineralogist 59, 1319-1326, 1974, with respect to which sources silicon and aluminum are assumed to be tetracoordinate and strontium nonacoordinate; for celsian: the data for the high temperature phase of hexacelsian are used, see Mineralogical Journal 2, 5, pages 311-332, 1958, with respect to which source silicon and aluminum are assumed to be tetracoordinate and barium dodecacoordinate; for hardystonite: Zeitschrift fur Kristallographie [Journal of Crystallography], Volume 130, pages 427-437 (1969), with respect to which source silicon and aluminum are assumed to be tetracoordinate and calcium octacoordinate; for titanite: American Mineralogist, Volume 61, pages 238-247, 1976, with respect to which source silicon is assumed to be tetracoordinate, titanium hexacoordinate and calcium heptacoordinate; for gittinsite: Canadian Mineralogist Vol. 27, pp. 703-708 (1989), with respect to which source silicon is assumed to be tetracoordinate, zirconium hexacoordinate and calcium also hexacoordinate.

The calculation rule for determining the 3D angular degrees of freedom f per atom in the finished glass is thus represented as follows:

$$f = \frac{{\sum }_{i = 1}^{n} {c}_{i} \cdot {z}_{i} \cdot {f}_{i}}{{\sum }_{i = 1}^{n} {c}_{i} \cdot {z}_{i}} , \qquad ( 3 )$$

wherein cᵢ is the molar percentage of the i-th constituent phase in the glass composition under consideration, zᵢ is the number of atoms per structural unit in the i-th constituent phase (or the number of atoms per mole in the i-th constituent phase; then in units of N_{A}, N_{A} Avogadro's number) and fᵢ the number of angular degrees of freedom per atom in the i-th constituent phase. “n” is the number of constituent phases.

The calculation rule for determining M/M_{SiO2} is as follows:

$$\frac{M}{{{M}_{SiO}}_{2}} = \frac{{\sum }_{i = 1}^{n} {c}_{i} \cdot {M}_{i}}{{M}_{{SiO}_{2}} \cdot {\sum }_{i = 1}^{n} c \text{?}} , \\ \text{?} \text{indicates text missing or illegible when filed} \qquad ( 4 )$$

wherein cᵢ is the molar percentage of the i-th constituent phase in the glass composition under consideration and n is the corresponding molar mass, “n” is the number of constituent phases.

The calculation rule for determining N/N_{SiO2} is as follows:

$$\frac{N}{{N}_{{SiO}_{2}}} = \frac{{\sum }_{i = 1}^{n} {c}_{i} \cdot {z}_{i}}{3 \cdot {\sum }_{i = 1}^{n} {c}_{i}} , \qquad ( 5 )$$

wherein cᵢ is the molar percentage of the i-th constituent phase in the glass composition under consideration and zᵢ is the number of atoms per structural unit in the i-th constituent phase (or the number of atoms per mole in the i-th constituent phase; then in units of N_{A}, N_{A} Avogadro's number), “n” is the number of constituent phases.

The factor (0.9483333-Λ) is associated with the driving force of the dissolution by the following consideration. The “more acidic” the glass is, the greater this driving force is, i.e. the higher the percentage of acid anhydrides is and the lower the percentage of base anhydrides. A quantitative measure of this is the optical basicity, see C. P. Rodriguez, J. S. McCloy, M. J. Schweiger, J. V. Crum, A, Winschell, Optical Basicity and Nepheline Crystallization in High Alumina Glasses, Pacific Northwest National Laboratories, PNNL 20184, EMSP-RPT 003, prepared for the US Department of Energy under contract DE-AC05-76RL01830. The lower the optical basicity is, the higher the driving force is. The case “driving force equal to zero” exists when the material is one in which the acid-base reaction has proceeded to completion. This last case is assumed particularly when the glass has the stoichiometry of sodium metasilicate, that is to say of the sodium silicate which has the highest sodium content of all sodium silicates occurring as solids (sodium orthosilicate only exists in aqueous solution). The optical basicity thereof, according to the method described in the following text for calculating the same, is precisely 0.9483333, that is to say the value at which by construction the abovementioned factor (0.9483333-Λ) is equal to zero.

The optical basicity Λ is calculated according to formula B.1 with the coefficients Λ_{χav} (optical basicity according to Li and Xue) according to Section B.1.6 and Table B.1 in C. P. Rodriguez, J. S. McCloy, M. J. Schweiger, J. V. Crum, A, Winschell, Optical Basicity and Nepheline Crystallization in High Alumina Glasses, Pacific Northwest National Laboratories, PNNL 20184, EMSP-RPT 003, prepared for the US Department of Energy under contract DE-AC05-76RL01830. Where several simple oxides are listed in the table for polyvalent ions, at first the oxide which is stoichiometrically compatible is chosen. In the present case, therefore, TiO2 is selected for titanium. Where only one coefficient is listed in the table for the simple oxide selected in this way, that coefficient is used. Where several coefficients are listed in the table for the selected simple oxide, the one that matches the coordination numbers of the respective cation in the constituent phases is used. For the base system described above, this is only necessary for aluminum oxide and magnesium oxide. Since aluminum is tetracoordinate in all constituent phases of the base system and it is also assumed the same in accordance with Conradt, loc. cit., the value indicated for the coordination number 4 for aluminum oxide in Table B.1 is used for the coefficient Λ_{ICP}. Since magnesium is hexacoordinate in the only constituent phase of the base system that contains magnesium, the value indicated for coordination number 6 for magnesium oxide in Table B.1 is used for the coefficient Λ_{χav}.

### Acid Resistance

Surprisingly, the removal rate in acid may also be estimated with the aid of an easily calculated relationship.

The starting point for the thinking behind this is initially the theory of Anderson and Stuart on ionic mobility in silica glasses, see O. L. Anderson, D. A. Stuart, Calculation of Activation Energy of Ionic Conductivity in Silica Glasses by Classical Methods, Journal of the American Ceramic Society, Vol. 37, No. 12 (1954), 573-580. According to this theory, the activation energy of the movement of a cation in a silica and thus also oxidic glass depends firstly on the electrostatic interaction with the surrounding oxygen ions that must be overcome, and secondly on the mechanical resistance that must be overcome during the transition from one mesh of the silica network to the next. According to Coulomb's law, the first component is proportional to the charge number of the cation in question and inversely proportional to the dielectric constant, the second component is proportional to the shear modulus and to the square of the dimension by which the diameter of the cation in question exceeds the mesh width of the network. Because of the first component, in general only singly charged cations are mobile and multiply charged cations such as aluminum are immobile.

In contact with a highly concentrated acid, 6N hydrochloric acid according to ISO 1776 and/or DIN 12116, the situation is different. In this case, protons or hydronium ions diffuse into the glass and form an electric double layer on the surface with the chloride ions that remain in the acid bath. The analysis of the eluate from measurements conducted according to ISO 1776 revealed that this electric double layer extends far enough to enable the electric field originating therefrom to compensate for the electrostatic interaction between the respective cation and the surrounding oxygen ions, with the result that even ions with a high charge number become mobile. (The force effect of the electric field of this double layer depends on the charge number of the cation in question just as much as the electrostatic interaction of said cation; the former may therefore be able to compensate for the latter.) It should also be borne in mind that the H₂O present in the hydronium ion H₃O⁺ additionally weakens the electrostatic interaction due to the very significant dielectric permeability of water. The swelling of the network weakens the mechanical cohesion in the same way.

It is observed that under identical test conditions (those of ISO 1776 or DIN 12116) considerably more aluminum ions leave an alkali-free display glass than sodium ions leave a soda-lime glass. This suggests that the decisive property for the mobility of an ion is its radius, which in turn is much smaller for an Al⁺⁺⁺ ion than for an Na⁺ ion. It is therefore more constructive to describe the movement of ions in the glass and out of the glass with the theory of the movement of particles in a viscous liquid than with the theory of Anderson and Stuart. According to Stokes-Einstein, the diffusion coefficient for a sphere in a viscous liquid is inversely proportional to the viscosity and to the radius of the sphere.

For a simple description of attack by acid the following model approach is posited. The topmost atom layers of the glass are considered:

In a first step, a certain number of the cations from these atom layers diffuses out into the acid. This number is proportional to the respective diffusion coefficient, which in turn is calculated by:

$${D}_{i , j} = \frac{const .}{{r}_{i , j}} \qquad ( 6 )$$

In this formula, r_{i,j} is the radius of the type “j” cation in the i-th constituent phase. This yields for the loss number Ω_{i,j} of type “j” cations in the i-th constituent phase:

Ω_{i,j}=z_{i,j}·D_{i,j} (7)

Here, z_{j,i} is the number of type j cations in the i-th constituent phase.

The viscosity that appears in the Stokes-Einstein equation has thereby been integrated in the constant; it is therefore assumed that the resulting viscosity for the softened “gel-like” glass is the same for all constituent phases under the test conditions. It is further assumed that the loss of cations that occurs in this first step is reflected in the loss balance as a corresponding loss of oxides and accordingly that as a result of this first step a mass loss ΔM₁ of the following magnitude occurs for one mole of glass:

$$Δ {M}_{1} = \frac{{\sum }_{i , j} {c}_{i} \cdot {Ω}_{i , j} \frac{{M}_{j}}{{Y}_{j}}}{{\sum }_{i} {c}_{i}} = \frac{{\sum }_{i , j} {c}_{i} \cdot {z}_{i , j} \cdot \frac{const .}{{r}_{i , j}} \frac{Me \text{?}}{\text{?}}}{\sum \text{?} {c}_{i}} \text{=:} const . \cdot \frac{{\sum }_{i , j} {c}_{i} \cdot \frac{z \text{?}}{r \text{?}} \frac{M \text{?}}{a \text{?}}}{{\sum }_{i} {c}_{i}} \\ \text{?} \text{indicates text missing or illegible when filed} \qquad ( 8 )$$

Meⱼ is the molar mass of the simple oxide belonging to the type “j” cation, and aⱼ is the number of type “j” cations in this oxide. The “const.” constant is determined empirically, so the model returns optimal results for the glass composition range provided according to the present invention. The numeric value is:

const.=0.73Å (9)

ΔM₁ is thus returned with the unit g/mol. r_{i,j} must be inserted in Å.

In a second step, conceptually distinct from the first step, the charge balance in the topmost atom layers of the glass is once again equalized by—this is the assumption of our model—the fact that as many hydronium ions diffuse in as are needed to compensate the charge. This number Z₂ is found for one mole of glass by:

Z₂=Σ_{i,k}cₜ·Ω_{i,j}·wⱼ (10)

wⱼ is the valency of a cation of the j-th type. Exactly as many H⁺ ions originating from the hydronium ions which have diffused in as correspond to the valency of the cation that has diffused out occupy the site of each cation that has diffused out.

Each hydronium ion also contains one H₂O, which in turn is able to break down an oxygen compound in the glass and replace it with two hydroxyl groups. If Z₂ is introduced into the ratio to the total number of oxygen atoms in the glass, an estimated value of that fraction of the glass which is dissolved by this breakdown of oxygen compounds is obtained. In this context, no distinction is made as to which cations are located on both sides of the oxygen compounds.

The total number of oxygen atoms O in one mole of glass is:

O=Σᵢcᵢ·0ᵢ (11)

Here, Oᵢ is the number of oxygen atoms in the i-th constituent phase.

The resulting loss of mass ΔM₂ is estimated with:

$$Δ {M}_{2} = M \cdot \frac{{z}_{2}}{o} \qquad ( 12 )$$

The cumulative loss or mass from steps 1 and 2 is calculated by

ΔM=ΔM₁+ΔM₂ (13)

By replacing the cations that diffuse out with the respective equivalent number of H⁺ ions, the topmost glass layer is softened still further and converted into a gel. The most abundant cation in this gel is silicon because, as will be explained further herein, silicon is the substance which diffuses out least readily.

If this situation were unchangeable in all cases, the gel created would make diffusion out of the glass and into the glass more difficult, with the result that as the dissolution proceeded, the dissolution rate would become lower and lower. Indeed, this also matches findings obtained during long-term measurements on acid-resistant glass such as Borofloat33™ manufactured by Schott.

However, due to the additional effect of the H₂O, parts of this gel are completely dissolved. In acid-resistant glass, this effect is minor, so the result is as described previously, namely that the glass dissolves slowly and the dissolution rate becomes slower over time.

What happens with less acid-resistant glass can best be illustrated with a thought experiment. A percentage of the topmost glass layer corresponding to the number of oxygen atoms originally present in the glass, may disappear completely, each being replaced by two OH groups during steps 1 and 2. Each hydronium ion results in the same number of OH groups as it contains H atoms, that is to say three OH groups. Consequently, one and a half times as many oxygen atoms are replaced as the number of hydronium ions that diffuse into the glass.

The proportion 6 of the topmost glass layer that disappears completely, exposing the glass layer immediately below it, is found with:

$$ɛ = \frac{3}{2} \cdot \frac{{z}_{2}}{o} \qquad ( 14 )$$

It is now posited that the further model approach, according to which the diffusive replacement of an exposed glass layer which is in direct contact with the acid takes place quickly, whereas the diffusive replacement slowed by a layer of gel takes place slowly.

Thus, one must also add the mass loss ϵ·ΔM which takes place in the exposed glass layer directly below, to the mass loss ΔM defined above from equation (12). Since a proportion ϵ of this directly underlying glass layer also disappears completely, the process continues in the manner of a geometric progression. One obtains for the total mass loss ΔM_{ges}:

$$Δ {M}_{ges} = Δ M + Δ M \cdot ɛ + Δ M \cdot {ɛ}^{2} + Δ M \cdot {ɛ}^{3} + ⋯ = \frac{Δ M}{1 - ɛ} \qquad ( 15 )$$

The denominator indicates that if ϵ≥1, the dissolution behavior will be catastrophic. This is also confirmed experimentally.

Since it has been defined with “mole” and “molar mass” (in grams) in all instances, the unit for ΔM_{ges} is “grams per mole”. With the aid of a prefactor f, which also incorporates the time over which ΔM_{ges} is removed, this is further converted below to “milligrams per square decimeter and six hours” (mg/(dm² 6 h), so that the variable is rendered comparable with the measurement parameter of DIN 12116.

The calculation of the removal in an acid resistance test according to DIN 12116 which is enabled thereby is carried out using the following Table 7.

TABLE 7

| Constituent phase | Stoichiometry | $const . \cdot {\sum }_{j} \frac{{z}_{i , j}}{{r}_{i , j}} \cdot \frac{{Me}_{j}}{{a}_{j}}$ | $const . \cdot {\sum }_{j} \frac{{z}_{i , j}}{{r}_{i , j}} \cdot {w}_{i}$ | Oᵢ |
|---|---|---|---|---|
| Silicon | SiO2 | 0 | 0 | 2 |
| dioxide | | | | |
| Wollastonite | (CaO·SiO2)/2 | 17.95524 | 0.64035 | 1.5 |
| Cordierite | (2MgO·2Al2O3·5SiO2)/9 | 38.81091 | 2.21373 | 2 |
| Anorthite | (CaO·Al2O3·2SiO2)/4 | 43.23192 | 2.35572 | 2 |
| Strontium- | (SrO·Al2O3·2SiO2)/4 | 48.15106 | 2.31776 | 2 |
| feldspar | | | | |
| Celsian | (BaO·Al2O3·2SiO2)/4 | 51.09937 | 2.27460 | 2 |
| Hardystonite | (2CaO·ZnO·2SiO2)/5 | 29.05211 | 0.85808 | 1.4 |
| Titanite | (CaO·TiO2·SiO2)/3 | 24.96047 | 1.08616 | 1.66666 |
| Gittinsite | (CaO·ZrO2·2SiO2)/4 | 24.85611 | 0.83563 | 1.75 |

The variable ΔM₁ is determined by multiplying the figures in the third column by cᵢ and then adding them together. The variable Z₂ is determined by multiplying the figures in the fourth column by cᵢ and then adding them together. The variable O is determined by multiplying the figures in the fifth column by cᵢ and then adding them together. The variable M is calculated as before.

Regarding calculation of the variables listed in the table, the following must also be noted. The variables z_{i,j} and Oⱼ are obtained directly from the stoichiometry. The molar masses of the simple oxides are generally known, as are the valencies of the cations. For the ion radii ri,j, the values are taken from R. D. Shannon, Revised Effective Ionic Radii and Systematic Studies of Interatomic Distances in Halides and Chalcogenides, Acta Cryst. A32 (1976), 751-767. Based on good experiences therewith in connection with ion conductivity, see DE102015005836, in this context reference is also made to the columns characterized with “CR” not those characterized with “IR”. In all cases, the ion radius selected is the one belonging to the coordination which exists in the constituent phase. The respective coordination number is taken from the aforementioned literature on the constituent phases.

The only approach changed is for the ions of silicon, titanium and zirconium, which do not exist as simple ions even in strongly acidic solutions. In strongly acidic aqueous solution, zirconium mainly has the form of ZrOH³⁺, see J. H. Adair, H. Krarup, S. Venigalla, and T. Tsukada, “A Review of the Aqueous Chemistry of the Zirconium-Water System to 200° C.,” invited paper in Aqueous Chemistry and Geochemistry of Oxides, Oxyhydroxides, and Related Materials, J. A. Voight, B. C. Bunker, W. H. Casey, T. E. Wood, and L. J. Crossey (eds.). MRS Volume 432, Materials Research Society, Pittsburgh, Pa., 1997, pp. 101-112. With the ion radius of zirconium in gittinsite, specifically 0.86 Å, see Shannon, loc. cit., and that of a twofold coordinate OH group (the lowest order listed in Shannon), specifically 1.18 Å, see Shannon, loc. cit., a structural unit is obtained having a radius of 2.04 Å in one dimension and a radius of 1.18 Å in each of the two other dimensions (for the radius in the two other dimensions the larger of the two values 0.86 Å and 1.18 Å is chosen). From this, an average radius of (2.04 Å·1.18 Å)^{(1/3)}=1.416 Å was calculated.

Tetravalent titanium may be present in strongly acidic aqueous solution as titanyl TiO²⁺, see D. Lundberg, I. Persson, Structure of a Hydrated Sulfonatotitanyl(IV) Complex in Aqueous Solution and the Dimethylsulfoxide Solvated Titanyl(IV) Ion in Solution and Solid State, Journal of Solution Chemistry 46, 2 (2017), 476-487. With the ion radius of titanium in titanite, specifically 0.745 Å, see Shannon, loc. cit., and that of an oxygen atom matching in terms of charge and coordination, specifically 1.22 Å, see Shannon, loc. cit., a structural unit is obtained having a radius of 1.965 Å in one dimension and a radius of 1.22 Å in each of the two other dimensions (for the radius in the two other dimensions the larger of the two values 0.745 Å and 1.22 Å is chosen). From this, one may calculate an average radius of (1.965 Å·1.22 Å)^{(1/3)}=1.43 Å.

Silicon exists in acidic aqueous solution as orthosilicic acid, not as ion, see S. Sjöberg, Silica in aqueous environments, Journal of Non-Crystalline Solids 196 (1996) 51-57. In view of both this and the fact that the removal rate for pure silica glass in tests according to DIN 12116 lies below the usual laboratory detection threshold, the participation of silicon in the aforementioned step 1 is evaluated as zero, and an infinitely large radius for the silicon ion is assumed.

From the variables ΔM₁, Z₂, O and M determined using Table 7, ΔM_{ges} is calculated in g/mol. With the aid of the prefactor f, a conversion is made to mg/(dm² 6 h). This prefactor is the same for all glass compositions within the range provided according to the present invention, since the glasses provided according to the present invention are similar enough in terms of density that a precise breakdown would not introduce significantly improved accuracy. The numeric value off which results in a best possible match between measured and calculated values for the removal rate according to DIN 12116 is:

$$f = 0.0096 \cdot \frac{mg}{{dm}^{2} 6 h} \cdot \frac{mol}{g} \qquad ( 16 )$$

### Coefficient of Thermal Expansion

Surprisingly, the position of the coefficient of thermal expansion in the target range may also be represented using a very simple calculation rule. This is found from the average bond strength.

It is known from the literature that the coefficient of thermal expansion e.g. for metals is inversely proportional to the bond energy (or to the “depth of the interatomic potential wells”), see for example H. Föll, lecture notes “Einführung in die Materialwissenschaft I” [Introduction to Materials Science I], Christian Albrechts University of Kiel, pages 79-83.

In a simple representation of oxidic glasses, the cations are placed in each potential well formed by the surrounding oxygen atoms and the depth thereof is assumed to be the sum of the bond strengths of the various single bonds with the surrounding oxygen atoms, thus concentrating all of the interaction energy in potential wells with the cations in the center and the oxygen atoms on the periphery. In this way, the converse case no longer has to be considered; it would also be more difficult to analyze, since one oxygen atom can be positioned between multiple cations of different kinds, which cannot happen in the opposite case in purely oxidic glasses. These values have been tabulated, for example in DE 10 2014 119 594 A1:

TABLE 8

| Cation | Potential well depth/(kJ/mol) |
|---|---|
| Si | 1864 |
| Ti | 1913 |
| Zr | 2204 |
| Al | 1537 |
| Zn | 728 |
| Mg | 999 |
| Ca | 1063 |
| Sr | 1005 |
| Ba | 976 |

The values for Ti, Zr, Sr, Ba and Zn are not taken from DE 10 2014 119 594 A1, but they have been calculated according to exactly the same method described in that document, with the sources cited therein.

From the composition of a glass from the constituent phases listed above, the numbers of different cations contained in the respective phases and the potential well depths per cation as shown in the table above, an average potential well depth can be calculated:

$${E}_{pot} = \frac{{\sum }_{i = 1}^{n} {c}_{i} \cdot {\sum }_{j = 1}^{m} {z}_{i , j} \cdot {E}_{pot , j}}{{\sum }_{i = 1}^{n} {c}_{i} {\sum }_{j = 1}^{m} {z}_{i , j}} , \qquad ( 17 )$$

Here, m is the number of cation types occurring, E_{pot,j} is the potential well depth listed in the table above for the j-th cation type, and z_{j,i} is the number of cations of the j-th type in the i-th constituent phase. The totals above j are listed in the following table:

TABLE 9

| Constituent phase | Formula (standardized to a simple oxide) | ${\sum }_{j = 1}^{m} {z}_{i , j}$ | ${\sum }_{j = 1}^{m} {z}_{i , j} \cdot {E}_{pot , j} / ( kJ \text{/} mol )$ |
|---|---|---|---|
| Silicon dioxide | SiO2 | 1 | 1864 |
| Wollastonite | (CaO·SiO2)/2 | 1 | 1463.5 |
| Cordierite | (2MgO·2Al2O3·5SiO2)/9 | 1.222222222 | 1940.666667 |
| Anorthite | (CaO·Al2O3·2SiO2)/4 | 1.25 | 1573 |
| Strontium-feldspar | (SrO·Al2O3·2SiO2)/4 | 1.25 | 1951.75 |
| Celsian | (BaO·Al2O3·2SiO2)/4 | 1.25 | 1944.5 |
| Hardystonite | (2CaO·ZnO2·2SiO2)/5 | 1 | 1316.4 |
| Titanite | (CaO·TiO2·SiO2)/3 | 1 | 1613.333333 |
| Gittinsite | (CaO·ZrO2·2SiO2)/4 | 1 | 1748.5 |

As for metals as well, for example, see H. Föll, loc. cit., this average bond strength is correlated in inverse proportion to the coefficient of thermal expansion. The evaluation of a series of glasses provided according to the present invention results in the following formula:

$$CTE = ( \frac{50067.4649 ( \frac{kJ}{Mol} )}{\overline{{E}_{pot}}} - 26.1377966 ) ppm \text{/} K \qquad ( 18 )$$

Since the bond strength is inversely proportional to the melting point, an inverse proportionality also exists between the melting point and the coefficient of expansion, see again H. Föll, loc. cit. Since the melting point is not precisely defined for non-stoichiometric glasses, only a tendential correlation exists between the temperature generally identified as the melting point, at which the viscosity is 100 dPas, and the coefficient of expansion. However, this is used to ensure that the glasses provided according to the present invention can be melted.

Whereas the requirement for good fusibility is suggested for the largest possible coefficient of thermal expansion, conversely the requirement for the lowest possible thermal stresses in the case of any thermal post-processing is suggestive of the lowest possible coefficient of thermal expansion. The combination of these two requirements leads to the average range for the coefficient of expansion and the average potential well depth described here.

### Selection of Suitable Constituent Phases

### Silicon Dioxide

In terms of the desired chemical resistance, silica glass is ideal. An exemplary constituent phase is therefore pure silicon dioxide. The disadvantages thereof are its low coefficient of thermal expansion and high melting temperature, which means that further constituent phases must be added to it.

The proportion of silicon dioxide in the glass provided according to the present invention is at least 20 mol % and not more than 80 mol %. Exemplary proportions in the glass provided according to the present invention are at least 25 mol %, at least 30 mol %, at least 35 mol % or at least 40 mol %. In some embodiments, the silicon dioxide content constitutes not more than 75 mol %, such as not more than 70 mol %, not more than 65 mol %, or not more than 60 mol %.

### Anorthite

In terms of chemical resistance, it is desirable that said further constituent phases extend the tetrahedral, three-dimensionally cross-linked network. For this, aluminosilicates in which the aluminum is present in tetrahedral coordination may be used. This generally occurs at the expense of alkaline or alkaline earth atoms, which are also introduced as oxides, and which lose their oxygen to the aluminum and then occupy a suitable space in the tetrahedral network as single ions. Borosilicates would also be feasible with regard to this aspect, but are disqualified for the reasons given previously. Since these reasons also exclude alkali ions, only the alkaline earth aluminosilicates are left. The most commonly used alkaline earth atom in glass is calcium, so anorthite is a prime candidate for use as the first aluminosilicate.

Anorthite belongs to the typical glass-forming systems, consisting of a network forming material (silicon oxide), an intermediate oxide (aluminum oxide) and a network converter (calcium oxide). It has ideal properties in terms of processing temperature and thermal expansion. The processing temperature is in the region of about 1100 ° C., see R. Knoche, D. B. Dingwell, and S. L. Webb, Temperature-dependent thermal expansivities of silicate melts: The system anorthite-diopside, Geochimica et Cosmochimica Acta 56 (1992), 689-699, and the coefficient of thermal expansion at about 5 ppm/K, see J. Arndt, F. Haberle, Thermal expansion and glass transition temperatures of synthetic glasses of plagioclase-like compositions, Contributions to Mineralogy and Petrology 39, 2 (1973), 175-183.

Chemical resistance, particularly acid resistance is problematic due to the high aluminum content. This might be addressed by mixing with silicon oxide, but that may adversely affect the coefficient of expansion. For this reason, other, aluminum-free constituent phases must be admixed. In order to be able to achieve all properties as desired, it is also advisable to admit not only anorthite but also all alkaline earth aluminosilicates.

According to the present invention, one mole of anorthite is understood to mean one mole of (CaO·Al₂O₃·2SiO₂)/4.

In the measurement of hydrolytic resistance, all components affect the pH value as hydroxides. Aluminum hydroxide and calcium hydroxide are poorly soluble in neutral aqueous solution and weakly alkaline solutions; but the solubility threshold lies well above the concentrations which occur during the measurements for hydrolytic resistance.

The proportion of anorthite in the glass provided according to the present invention is 0 mol % to 40 mol %. Exemplary proportions in the glass provided according to the present invention are at least 1 mol %, at least 2 mol %, at least 5 mol % or at least 10 mol %. In some embodiments, the anorthite content is not more than 35 mol %, such as not more than 30 mol %, not more than 25 mol %, or not more than 20 mol %.

### Cordierite, Strontium-Feldspar, Celsian

For the reasons given previously, all alkaline earth aluminosilicates are constituent phases according to the present invention.

According to the present invention, one mole of cordierite is understood to mean one mole of (2MgO·2Al₂O₃·5SiO₂)/9. The proportion of cordierite in the glass provided according to the present invention is 0 mol % to 30 mol %. Exemplary proportions in the glass provided according to the present invention are at least 1 mol %, at least 2 mol %, at least 3 mol % or at least 4 mol %. In some embodiments, the cordierite content is not more than 25 mol %, not more than 20 mol %, not more than 15 mol %, or not more than 10 mol %.

According to the present invention, one mole of strontium-feldspar is understood to mean one mole of (SrO·Al₂O₃·2SiO₂)/4. The proportion of strontium-feldspar in the glass provided according to the present invention is 0 mol % to 40 mol %. Exemplary proportions in the glass provided according to the present invention are at least 1 mol %, at least 2 mol %, at least 5 mol % or at least 10 mol %. In some embodiments, the strontium-feldspar content is not more than 35%, not more than 30 mol %, not more than 25 mol %, or not more than 20 mol %.

According to the present invention, one mole of celsian is understood to mean one mole of (BaO·Al₂O₃·2SiO₂)/4. The proportion of celsian in the glass provided according to the present invention is 0 mol % to 20 mol %. Exemplary proportions in the glass provided according to the present invention are at least 1 mol %, at least 2 mol %, at least 3 mol % or at least 4 mol %. In some embodiments, the celsian content is not more than 17.5 mol %, such as not more than 15 mol %, not more than 12.5 mol %, or not more than 10 mol %.

In the measurement of hydrolytic resistance, all components affect the pH value as hydroxides. Aluminum hydroxide and calcium hydroxide are poorly soluble in neutral aqueous solution and weakly alkaline solutions; but the solubility threshold lies well above the concentrations which occur during the measurements for hydrolytic resistance.

### Hardystonite

Like the constituent phases described above, hardystonite consists of a proportion of network forming material, a proportion of intermediate oxide and a proportion of a network converter. It is not naturally a three-dimensional network forming material, but rather a sheet silicate. However, it contributes to the tetrahedral extension of the network, since the zinc contained therein as intermediate oxide is tetrahedral. It has a lower valency than aluminum (advantageous for acid resistance) and a larger ion radius (also advantageous for acid resistance). By virtue of its very high coefficient of expansion, it lends itself well to compensating for the expansion inhibiting effect of silicon dioxide.

According to the present invention, one mole of hardystonite is understood to mean one mole of (2CaO·ZnO·2SiO₂)/5. The proportion of hardystonite in the glass provided according to the present invention is 0 mol % to 40 mol %. Exemplary proportions in the glass provided according to the present invention are at least 1 mol %, at least 2 mol %, at least 5 mol % or at least 10 mol %. In some embodiments, the hardystonite content is not more than 35 mol %, not more than 30 mol %, not more than 25 mol %, or not more than 20 mol %.

In the measurement of hydrolytic resistance, all components affect the pH value as hydroxides. Zinc hydroxide is poorly soluble in neutral aqueous solution; but the solubility threshold lies well above the concentrations which occur during the measurements for hydrolytic resistance.

### Gittinsite

Like the constituent phases described above, gittinsite consists of a proportion of network forming material, a proportion of intermediate oxide and a proportion of network converter. As was noted previously, the cation of the intermediate oxide, that is to say zirconium, cannot diffuse out of the glass readily in the case of attack by acid according to DIN 12116. This is advantageous for acid resistance, and it was with this in mind that gittinsite was chosen.

According to the present invention, one mole of gittinsite is understood to mean one mole of (CaO·ZrO2·2SiO2)/4. The proportion of gittinsite in the glass provided according to the present invention is 0 mol % to 15 mol %. Exemplary proportions in the glass provided according to the present invention are at least 1 mol %, at least 2 mol %, at least 3 mol % or at least 4 mol %.

In some embodiments, the gittinsite content is not more than 17.5 mol %, not more than 15 mol %, not more than 12.5 mol %, or not more than 10 mol %.

In the measurement of hydrolytic resistance, all components affect the pH value as hydroxides.

### Titanite

Like the constituent phases described previously, titanite consists of a proportion of network forming material, a proportion of intermediate oxide and a proportion of network converter. As was noted previously, the cation of the intermediate oxide, that is to say titanium, cannot diffuse out of the glass readily in the case of attack by acid according to DIN 12116. This is advantageous for acid resistance, and it was with this in mind that titanite was chosen.

The titanium contained is precipitated as titanium dioxide in aqueous solution and alkaline solutions and does not affect the measurement of hydrolytic resistance.

One mole of titanite is understood to mean one mole of (CaO·TiO₂·SiO₂)/3. The proportion of titanite in the glass provided according to the present invention is 0 mol % to 10 mol %. Exemplary proportions in the glass provided according to the present invention are at least 0.15 mol %, at least 0.25 mol %, at least 0.5 mol % or at least 1 mol %. In some embodiments, the titanite content is not more than 7.5 mol %, not more than 5 mol %, not more than 2.5 mol %, or not more than 1.5 mol %.

### Wollastonite

Wollastonite is a chain silicate which may be included for fine adjustment of the calcium proportion. One mole of wollastonite is understood to mean one mole of (CaO·SiO₂)/2. The proportion of wollastonite in the glass provided according to the present invention is 0 mol % to 40 mol %. Exemplary proportions in the glass provided according to the present invention are at least 1 mol %, at least 2 mol %, at least 5 mol % or at least 10 mol %. In some embodiments, the wollastonite content is not more than 35 mol %, not more than 30 mol %, not more than 25 mol %, or not more than 20 mol %.

In the measurement of hydrolytic resistance, all components affect the pH value as hydroxides.

### Other Components

Besides the components named previously, the glass may contain further components, which are referred to here as “remainder”. In some embodiments, the proportion of the remainder in the glass provided according to the present invention is not more than 3 mol % to avoid interfering with the glass properties established by careful selection of suitable base glasses. In some embodiments, the content of individual oxides is limited to <0.5 mol %. In some embodiments, the proportion of the remainder in the glass accounts for not more than 2 mol %, such as not more than 1 mol % or not more than 0.5 mol %. The remainder particularly contains oxides which are not contained in the named base glasses. Thus the remainder particularly does not contain SiO₂, Al₂O₃, ZrO₂, TiO₂, ZnO, MgO, CaO, SrO, BaO.

Where it is stated herein that the glasses are free from a component or a constituent phase or do not contain a certain component or constituent phase, this is intended to mean that this component or constituent phase is permitted to exist as a contaminant in the glasses if unavoidable. This means that it is not added in significant quantities. Insignificant quantities according to the present invention are quantities of less than 5000 ppm (molar, relative to the oxides), such as less than 4000 ppm (molar, relative to the oxides), less than 3000 ppm (molar, relative to the oxides), less than 2000 ppm (molar, relative to the oxides), less than 1000 ppm (molar, relative to the oxides), less than 300 ppm (molar, relative to the oxides), less than 100 ppm (molar, relative to the oxides), less than 50 ppm (molar, relative to the oxides), or less than 10 ppm (molar, relative to the oxides). The glasses of this invention are in particular free from lead, arsenic, antimony, bismuth and/or cadmium.

As was noted previously, one cause of delamination is the vaporization of alkali borates or boron- and alkali hydroxides during hot forming. The glasses provided according to the present invention are therefore free from boron and free from alkali metals. In particular, the glasses provided according to the present invention are free from Li, Na, K, Rb and Cs. In other words, the glass contains less than 5000 ppm (molar, relative to the oxides), such as less than 4000 ppm (molar, relative to the oxides), less than 3000 ppm (molar, relative to the oxides), less than 2000 ppm (molar, relative to the oxides), less than 1000 ppm (molar, relative to the oxides), less than 300 ppm (molar, relative to the oxides), less than 100 ppm (molar, relative to the oxides), less than 50 ppm (molar, relative to the oxides), or less than 10 ppm (molar, relative to the oxides) of each of the components B₂O₃, Li₂O, Na₂O, K₂O, Rb₂O and Cs₂O.

The remainder does not appear in the formulas. All calculations are carried out as if the content consisting of the constituent phases accounts for 100% of the formula.

### Exemplary Glass Compositions

The exemplary embodiments are obtained within the framework of the base system described previously from the specification of a desired thermal expansion and a desired range for the thermal expansion.

The solution to the previously described problems then consists in achieving a combination of a low removal rate in alkaline medium (see above, ISO 695), a low pH value and a high acid resistance while observing the specifications. This is done with the aid of the formulas described previously.

An exemplary composition is characterized by the following constituent phases of the glass:

TABLE 10

| Constituent phase | Min (mol %) | Max (mol %) |
|---|---|---|
| Silicon dioxide | 25 | 75 |
| Wollastonite | 0 | 35 |
| Cordierite | 0 | 25 |
| Anorthite | 0 | 35 |
| Strontium-feldspar | 1 | 35 |
| Celsian | 0 | 17.5 |
| Hardy stonite | 1 | 35 |
| Titanite | 0 | 7.5 |
| Gittinsite | 0 | 10 |

A further exemplary composition is characterized by the following constituent phases of the glass:

TABLE 11

| Constituent phase | Min (mol %) | Max (mol %) |
|---|---|---|
| Silicon dioxide | 30 | 70 |
| Wollastonite | 0 | 30 |
| Cordierite | 0 | 20 |
| Anorthite | 0 | 30 |
| Strontium-feldspar | 2 | 30 |
| Celsian | 0 | 15 |
| Hardystonite | 2 | 30 |
| Titanite | 0 | 5 |
| Gittinsite | 0 | 7.5 |

A further exemplary composition is characterized by the following constituent phases of the glass:

TABLE 12

| Constituent phase | Min (mol %) | Max (mol %) |
|---|---|---|
| Silicon dioxide | 35 | 65 |
| Wollastonite | 0 | 25 |
| Cordierite | 0 | 15 |
| Anorthite | 0 | 25 |
| Strontium-feldspar | 5 | 25 |
| Celsian | 0 | 10 |
| Hardy stonite | 3 | 25 |
| Titanite | 0 | 2 |
| Gittinsite | 0 | 5 |

A further exemplary composition is characterized by the following constituent phases of the glass:

TABLE 13

| Constituent phase | Min (mol %) | Max (mol %) |
|---|---|---|
| Silicon dioxide | 40 | 60 |
| Wollastonite | 0 | 20 |
| Cordierite | 0 | 10 |
| Anorthite | 0 | 20 |
| Strontium-feldspar | 7.5 | 20 |
| Celsian | 0 | 5 |
| Hardystonite | 4 | 20 |
| Titanite | 0 | 1 |
| Gittinsite | 0 | 4 |

### Production

A method for producing a glass provided according to the present invention is also provided. The method includes the steps of:
melting glass raw materials to form a molten glass,
optionally forming a glass item, particularly a glass tube or a glass fiber, from the molten glass,
cooling the molten glass.

Forming the glass may comprise a drawing process, particularly a tube drawing process or a drawing process for flat glass and/or fibers. The cooling step may involve active cooling with the use of a coolant, for example a cooling fluid, or passively allowing the product to cool.

### Uses and Glass Items

In addition to the glass, the glass items formed from the glass such as glass tubes and receptacles (such as flasks, ampoules, carpules, syringes) and the use thereof in the production of glass tubes and pharmaceutical receptacles, particularly primary packaging materials, are also provided according to the present invention. The glass items may be intended for use as packaging materials for pharmaceutical products, particularly as containers for liquids. Within the scope of these uses, hydrolytic resistance and resistance to alkaline solutions are of particular interest.

The present invention also relates to the use of the glass provided according to the present invention for fiber-reinforced plastics.

Comparative Examples from the Prior Art

### Comparative Examples 1-10

Comparative examples 1-10 are the examples of EP0510544 identified as such therein by numbers 1-10. Of these, numbers 1-6 and 8-10 contain >0.5 mol % B₂O₃ and are therefore not consistent with the present invention. Example 7 has the composition:

TABLE 14

| | | 7 |
|---|---|---|
| # | Oxide | Mol % |
| 1. | SiO₂ | 71.7 |
| 2. | TiO₂ | 0 |
| 3. | ZrO₂ | 0 |
| 4. | Al₂O₃ | 11.1 |
| 5. | ZnO | 0 |
| 6. | MgO | 0 |
| 7. | CaO | 15.2 |
| 8. | SrO | 1 |
| 9. | BaO | 1 |

The conversion to constituent phases yields:

TABLE 15

| | 7 |
|---|---|
| Constituent phase | Mol % |
| Silicon dioxide | 21.76 |
| Wollastonite | 14.715 |
| Cordierite | 2.8 |
| Anorthite | 22.88 |
| Strontium-feldspar | 0 |
| Celsian | 12.15 |
| Hardy stonite | 0 |
| Titanite | 0 |
| Gittinsite | 21.76 |

The gittinsite content is too high.

The calculated properties are:

TABLE 16

| | ISO 695: | DIN 12116: | | |
|---|---|---|---|---|
| Seq. | calculated removal | calculated removal | Calculated | |
| no. | rate/mg/(dm²3h) | rate/mg/(dm²6h) | CTE/(ppm/K) | pH |
| 7 | 95.95507922 | 16.83482898 | 5.342224985 | |

The calculated removal rate in the alkaline solution test and the acid test is too high. The pH value was therefore not calculated.

### Comparative Examples 11-21

Comparative examples 11-21 are the examples of U.S. Pat. No. 9,061,938 identified therein as glass 1-10. Examples 5 and 9 contain >0.5% B₂O₃ and are therefore not consistent with the present invention. The other examples have the composition:

TABLE 17

| | | 1 | | | | | | | |
|---|---|---|---|---|---|---|---|---|---|
| # | Oxide | Mol % | 2 | 3 | 4 | 6 | 7 | 8 | 10 |
| 1. | SiO₂ | 72.43 | 71.75 | 71.33 | 70.13 | 71.40 | 71.29 | 67.91 | 70.92 |
| 2. | TiO₂ | 0.00 | 0.00 | 0.00 | 0.00 | 0.00 | 0.00 | 0.00 | 0.00 |
| 3. | ZrO₂ | 0.00 | 0.00 | 0.00 | 0.00 | 0.00 | 0.00 | 0.00 | 0.00 |
| 4. | Al₂O₃ | 10.70 | 10.60 | 10.54 | 10.36 | 10.81 | 10.89 | 11.67 | 10.71 |
| 5. | ZnO | 0.00 | 0.00 | 0.00 | 0.00 | 0.00 | 0.00 | 0.00 | 0.00 |
| 6. | MgO | 0.00 | 3.37 | 0.00 | 3.30 | 0.00 | 3.40 | 0.00 | 0.33 |
| 7. | CaO | 11.51 | 8.97 | 13.74 | 12.33 | 11.82 | 9.53 | 18.25 | 15.71 |
| 8. | SrO | 1.32 | 1.31 | 1.30 | 1.28 | 0.34 | 0.33 | 0.00 | 1.27 |
| 9. | BaO | 4.03 | 3.99 | 3.09 | 2.60 | 5.64 | 4.56 | 2.17 | 1.07 |

The compositions have all been standardized to 100% with the omission of the remainder. This remainder is represented consistently by 0.3 percent by weight Sn₂O₃, and in the case of Example 7 an additional 0.5 percent by weight B₂O₃, and for Example 10 a further 0.2 percent by weight B₂O₃.

The conversion to constituent phases yields:

TABLE 18

| Constituent | 1 | | | | | | | |
|---|---|---|---|---|---|---|---|---|
| phase | Mol % | 2 | 3 | 4 | 6 | 7 | 8 | 10 |
| Silicon | 44.87 | 41.83 | 42.65 | 38.61 | 42.79 | 40.88 | 35.83 | 41.67 |
| dioxide | | | | | | | | |
| Wollastonite | 12.32 | 14.08 | 15.18 | 18.29 | 13.97 | 13.87 | 17.50 | 15.35 |
| Cordierite | 0.00 | 15.17 | 0.00 | 14.84 | 0.00 | 15.30 | 0.00 | 1.47 |
| Anorthite | 21.40 | 7.72 | 24.60 | 12.73 | 19.33 | 10.39 | 38.00 | 32.15 |
| Strontium- | 5.28 | 5.24 | 5.22 | 5.13 | 1.35 | 1.32 | 0.00 | 5.08 |
| feldspar | | | | | | | | |
| Celsian | 16.12 | 15.96 | 12.34 | 10.40 | 22.56 | 18.24 | 8.67 | 4.29 |
| Hardystonite | 0.00 | 0.00 | 0.00 | 0.00 | 0.00 | 0.00 | 0.00 | 0.00 |
| Titanite | 0.00 | 0.00 | 0.00 | 0.00 | 0.00 | 0.00 | 0.00 | 0.00 |
| Gittinsite | 0.00 | 0.00 | 0.00 | 0.00 | 0.00 | 0.00 | 0.00 | 0.00 |

The calculated properties are:

TABLE 19

| | ISO 695: | DIN 12116: | | |
|---|---|---|---|---|
| Seq. | calculated removal | calculated removal | Calculated | |
| no. | rate/mg/(dm² 3 h) | rate/mg/(dm² 6 h) | CTE/(ppm/K) | pH |
| 1 | 86.26 | 3.39 | 3.75 | |
| 2 | 86.07 | 3.87 | 3.88 | |
| 3 | 86.17 | 3.62 | 3.89 | |
| 4 | 85.93 | 4.32 | 4.09 | |
| 6 | 89.41 | 3.89 | 3.90 | |
| 7 | 87.20 | 4.54 | 3.93 | |
| 8 | 90.00 | 11.4 | 4.25 | |
| 10 | 83.95 | 4.09 | 3.91 | |

The calculated removal rate in the alkaline solution test is too high in all examples. The pH values were therefore not calculated.

### Comparative Examples 21-51

Comparative examples 21-51 are the examples of U.S. Pat. No. 9,670,087 identified therein as glass 1-31. All of the examples contain >11.5% Al₂O₃ and are therefore not consistent with the present invention.

### Comparative examples 52-59

Comparative examples 52-59 are the examples of JPH05155638 identified therein as glass 1-8. Glass 8 contains more than 0.5 mol % Na₂O. The other examples have the composition:

TABLE 20

| | | 1 | | | | | | |
|---|---|---|---|---|---|---|---|---|
| # | Oxide | Mol % | 2 | 3 | 4 | 5 | 6 | 7 |
| 1. | SiO₂ | 63.21 | 61.97 | 60.70 | 61.91 | 61.19 | 60.97 | 60.42 |
| 2. | TiO₂ | 0.78 | 1.26 | 0.63 | 0.79 | 1.27 | 0.95 | 0.66 |
| 3. | ZrO₂ | 0.51 | 1.02 | 1.53 | 0.51 | 0.93 | 1.54 | 1.60 |
| 4. | Al₂O₃ | 6.44 | 6.49 | 7.10 | 6.53 | 6.54 | 5.58 | 7.39 |
| 5. | ZnO | 2.31 | 2.32 | 0.00 | 2.34 | 2.34 | 3.10 | 3.22 |
| 6. | MgO | 3.88 | 3.91 | 5.47 | 3.93 | 3.94 | 5.49 | 2.44 |
| 7. | CaO | 22.87 | 23.03 | 24.15 | 23.16 | 23.21 | 21.96 | 22.78 |
| 8. | SrO | 0.00 | 0.00 | 0.00 | 0.00 | 0.00 | 0.00 | 0.00 |
| 9. | BaO | 0.00 | 0.00 | 0.41 | 0.83 | 0.58 | 0.41 | 1.50 |

The compositions have all been standardized to 100% with the omission of the remainder. This remainder is represented consistently by 0.8 percent by weight for the total of Na₂O and K₂O.

The conversion to constituent phases shows that Example 6 does not belong to the base system provided according to the present invention. For the other glasses the composition in constituent phases is as follows:

TABLE 21

| Constituent | 1 | | | | | |
|---|---|---|---|---|---|---|
| phase | Mol % | 2 | 3 | 4 | 5 | 7 |
| Silicon dioxide | 27.56 | 25.57 | 19.30 | 24.98 | 24.02 | 23.49 |
| Wollastonite | 28.81 | 27.04 | 41.52 | 30.83 | 28.62 | 21.27 |
| Cordierite | 17.46 | 17.58 | 24.62 | 17.69 | 17.72 | 10.97 |
| Anorthite | 10.25 | 10.32 | 4.89 | 7.07 | 8.08 | 13.82 |
| Strontium- | 0.00 | 0.00 | 0.00 | 0.00 | 0.00 | 0.00 |
| feldspar | | | | | | |
| Celsian | 0.00 | 0.00 | 1.64 | 3.31 | 2.32 | 5.98 |
| Hardystonite | 11.53 | 11.61 | 0.00 | 11.68 | 11.70 | 16.10 |
| Titanite | 2.35 | 3.78 | 1.89 | 2.38 | 3.81 | 1.97 |
| Gittinsite | 2.03 | 4.09 | 6.13 | 2.06 | 3.71 | 6.38 |

Example 3 contains too much wollastonite.

The calculated properties are:

TABLE 22

| | ISO 695: | DIN 12116: | | |
|---|---|---|---|---|
| Seq. | calculated removal | calculated removal | Calculated | |
| no. | rate/mg/(dm² 3 h) | rate/mg/(dm² 6 h) | CTE/(ppm/K) | pH |
| 1 | 86.87 | 2.69 | 5.19 | 9.27 |
| 2 | 89.56 | 3.16 | 5.19 | |
| 3 | 91.25 | 4.57 | 5.2 | |
| 4 | 90.02 | 3.16 | 5.39 | |
| 5 | 91.52 | 3.51 | 5.33 | |
| 7 | 96.38 | 5.49 | 5.38 | |

The calculated removal rate in the alkaline solution test is too high in all examples. The pH value was also calculated for Example 1; it is very high. (NB: a pH value calculation taking into account the aforementioned remainder amounting to 0.8 percent by weight of Na₂O and K₂O yields an even higher value than 9.27, since both Na₂O and K₂O form strongly alkaline solutions in aqueous solution.)

### Comparative Examples 60-111

Comparative examples 60-111 are the examples of U.S. Pat. No. 9,586,854 identified therein as glass 1-52. Examples 1-48 as well as 51 and 52 contain >2% B₂O₃ and are therefore not consistent with the present invention. The other examples have the composition:

TABLE 23

| | | 49 | |
|---|---|---|---|
| # | Oxide | Mol % | 50 |
| 1. | SiO₂ | 71.07 | 70.50 |
| 2. | TiO₂ | 0.00 | 0.00 |
| 3. | ZrO₂ | 0.00 | 0.00 |
| 4. | Al₂O₃ | 8.91 | 10.40 |
| 5. | ZnO | 0.00 | 0.00 |
| 6. | MgO | 0.00 | 0.00 |
| 7. | CaO | 17.92 | 16.00 |
| 8. | SrO | 0.00 | 0.00 |
| 9. | BaO | 2.10 | 3.10 |

The composition of No. 49 was standardized to 100%, ignoring 0.1 mol % SnO₂. The composition of No. 50 in U.S. Pat. No. 9,586,854 adds up to 100.1 mol %, of which 0.1 mol % is SnO₂; these two compositions were omitted here. The conversion to constituent phases thus yields:

TABLE 24

| | | 49 | |
|---|---|---|---|
| # | Constituent phase | Mol % | 50 |
| 1. | Silicon dioxide | 42.14 | 41.00 |
| 2. | Wollastonite | 22.22 | 17.40 |
| 3. | Cordierite | 0.00 | 0.00 |
| 4. | Anorthite | 27.23 | 29.20 |
| 5. | Strontium-feldspar | 0.00 | 0.00 |
| 6. | Celsian | 8.41 | 12.40 |
| 7. | Hardystonite | 0.00 | 0.00 |
| 8. | Titanite | 0.00 | 0.00 |
| 9. | Gittinsite | 0.00 | 0.00 |

The calculated properties are:

TABLE 25

| | ISO 695: | DIN 12116: | | |
|---|---|---|---|---|
| Seq. | Calculated removal | Calculated removal | Calculated | |
| no. | rate/mg/(dm² 3 h) | rate/mg/(dm² 6 h) | CTE/(ppm/K) | pH |
| 49 | 81.99 | 2.28 | 3.99 | 9.105 |
| 50 | 86.16 | 3.77 | 4.00 | |

For Example 50, the calculated removal rate in the acid test is too high. The calculated removal rate in the alkaline solution test is also too high in both examples. The pH value was also calculated for Example 49; the value is very high.

### Comparative Examples 112-116

Comparative examples 112-116 are the examples of DE 1816391 identified therein as glass 1-5. Examples 2-5 contain ≥12% Al₂O₃ and are therefore not consistent with the present invention. Example 1 has the composition:

TABLE 26

| | | 1 |
|---|---|---|
| # | Oxide | Mol % |
| 1. | SiO₂ | 75.9 |
| 2. | TiO₂ | 0 |
| 3. | ZrO₂ | 0 |
| 4. | Al₂O₃ | 11.4 |
| 5. | ZnO | 0 |
| 6. | MgO | 0 |
| 7. | CaO | 0 |
| 8. | SrO | 0 |
| 9. | BaO | 12.7 |

The conversion to constituent phases reveals that Example 1 does not belong to the base system provided according to the present invention.

### Comparative Examples 117-126

Comparative examples 117-126 are the examples of U.S. Pat. No. 4,012,263 identified therein as glass I-X. The other examples have the composition:

TABLE 27

| | | I | | | | | | | | | |
|---|---|---|---|---|---|---|---|---|---|---|---|
| # | Oxide | Mol % | II | III | IV | V | VI | VII | VIII | IX | X |
| 1. | SiO₂ | 71 | 70.00 | 71.00 | 71.00 | 66.00 | 75.90 | 66.00 | 68.00 | 66.00 | 67.00 |
| 2. | TiO₂ | 0 | 0.00 | 0.00 | 0.00 | 0.00 | 0.00 | 0.00 | 0.00 | 0.00 | 0.00 |
| 3. | ZrO₂ | 0 | 0.00 | 0.00 | 0.00 | 0.00 | 0.00 | 0.00 | 0.00 | 0.00 | 0.00 |
| 4. | Al₂O₃ | 8 | 8.00 | 10.00 | 9.00 | 8.00 | 7.70 | 8.00 | 8.00 | 8.00 | 8.00 |
| 5. | ZnO | 0 | 0.00 | 0.00 | 0.00 | 0.00 | 0.00 | 0.00 | 0.00 | 0.00 | 0.00 |
| 6. | MgO | 0 | 0.00 | 0.00 | 0.00 | 0.00 | 0.00 | 0.00 | 0.00 | 4.00 | 4.00 |
| 7. | CaO | 11 | 11.00 | 10.00 | 10.00 | 13.00 | 0.00 | 18.00 | 17.00 | 15.00 | 14.00 |
| 8. | SrO | 0.00 | 0.00 | 0.00 | 0.00 | 0.00 | 0.00 | 0.00 | 0.00 | 0.00 | 0.00 |
| 9. | BaO | 10.00 | 11.00 | 9.00 | 10.00 | 13.00 | 16.40 | 8.00 | 7.00 | 7.00 | 7.00 |

The conversion to constituent phases reveals that Examples I, II, IV-VI, IX, X do not belong to the base system provided according to the present invention. For the other examples, the following results are obtained:

TABLE 28

| | | III | | |
|---|---|---|---|---|
| # | Constituent phase | Mol % | VII | VIII |
| 1. | Silicon dioxide | 42.00 | 32.00 | 36.00 |
| 2. | Wollastonite | 18.00 | 36.00 | 32.00 |
| 3. | Cordierite | 0.00 | 0.00 | 0.00 |
| 4. | Anorthite | 4.00 | 0.00 | 4.00 |
| 5. | Strontium-feldspar | 0.00 | 0.00 | 0.00 |
| 6. | Celsian | 36.00 | 32.00 | 28.00 |
| 7. | Hardystonite | 0.00 | 0.00 | 0.00 |
| 8. | Titanite | 0.00 | 0.00 | 0.00 |
| 9. | Gittinsite | 0.00 | 0.00 | 0.00 |

The examples thus contain too much celsian.

The calculated properties are:

TABLE 29

| | ISO 695: | DIN 12116: | | |
|---|---|---|---|---|
| Seq. | calculated removal | calculated removal | Calculated | |
| No. | rate/mg/(dm² 3 h) | rate/mg/(dm² 6 h) | CTE/(ppm/K) | pH |
| III | 86.16 | 3.77 | 4.00 | |
| VII | 96.4 | 2.73 | 4.84 | 9.241 |
| VIII | 91.98 | 2.31 | 4.54 | 9.198 |

For Example III, the calculated removal rate in the acid test is too high. The calculated removal rates in the alkaline solution tests are too high for all three examples. Moreover, the calculated pH values of Examples VII and VIII are very high.

### Comparative Examples 127-133

Comparative examples 127-133 are the examples of EP0048120 identified therein as glass 1-7. They have the composition:

TABLE 30

| | | 1 | | | | | | |
|---|---|---|---|---|---|---|---|---|
| # | Oxide | Mol % | 2 | 3 | 4 | 5 | 6 | 7 |
| 1. | SiO₂ | 71.78 | 71.68 | 71.69 | 71.97 | 73.01 | 71.73 | 71.72 |
| 2. | TiO₂ | 0.00 | 0.00 | 0.00 | 0.00 | 0.00 | 0.00 | 0.00 |
| 3. | ZrO₂ | 0.00 | 0.00 | 0.00 | 0.00 | 0.00 | 0.00 | 0.00 |
| 4. | Al₂O₃ | 11.12 | 11.13 | 11.13 | 10.84 | 10.96 | 11.09 | 11.09 |
| 5. | ZnO | 0.00 | 0.00 | 0.00 | 0.00 | 0.00 | 0.00 | 0.00 |
| 6. | MgO | 0.00 | 0.00 | 0.00 | 0.00 | 0.00 | 0.00 | 0.00 |
| 7. | CaO | 15.08 | 15.17 | 14.11 | 17.19 | 14.02 | 14.11 | 15.18 |
| 8. | SrO | 1.01 | 0.00 | 2.04 | 0.00 | 2.01 | 1.03 | 2.01 |
| 9. | BaO | 1.00 | 2.02 | 1.03 | 0.00 | 0.00 | 2.04 | 0.00 |

The conversion to constituent phases yields:

TABLE 31

| | Constituent | 1 | | | | | | |
|---|---|---|---|---|---|---|---|---|
| # | phase | Mol % | 2 | 3 | 4 | 5 | 6 | 7 |
| 1. | Silicon dioxide | 43.57 | 43.36 | 43.38 | 43.95 | 46.02 | 43.46 | 43.44 |
| 2. | Wollastonite | 11.95 | 12.13 | 12.11 | 12.70 | 10.13 | 12.18 | 12.20 |
| 3. | Cordierite | 0.00 | 0.00 | 0.00 | 0.00 | 0.00 | 0.00 | 0.00 |
| 4. | Anorthite | 36.42 | 36.42 | 32.23 | 43.36 | 35.82 | 32.09 | 36.34 |
| 5. | Strontium- | 4.05 | 0.00 | 8.15 | 0.00 | 8.03 | 4.11 | 8.03 |
| | feldspar | | | | | | | |
| 6. | Celsian | 4.02 | 8.09 | 4.13 | 0.00 | 0.00 | 8.16 | 0.00 |
| 7. | Hardystonite | 0.00 | 0.00 | 0.00 | 0.00 | 0.00 | 0.00 | 0.00 |
| 8. | Titanite | 0.00 | 0.00 | 0.00 | 0.00 | 0.00 | 0.00 | 0.00 |
| 9. | Gittinsite | 0.00 | 0.00 | 0.00 | 0.00 | 0.00 | 0.00 | 0.00 |

Example 4 contains too much anorthite.

The calculated properties are:

TABLE 32

| | ISO 695: | DIN 12116: | | |
|---|---|---|---|---|
| Seq. | calculated removal | calculated removal | Calculated | |
| no. | rate/mg/(dm² 3 h) | rate/mg/(dm² 6 h) | CTE/(ppm/K) | pH |
| 1 | 83.21 | 4.26 | 3.77 | |
| 2 | 84.07 | 4.31 | 3.79 | |
| 3 | 84.10 | 4.32 | 3.79 | |
| 4 | 80.49 | 3.78 | 3.74 | |
| 5 | 80.76 | 3.51 | 3.62 | |
| 6 | 84.71 | 4.21 | 3.79 | |
| 7 | 82.54 | 4.27 | 3.78 | |

The calculated removal rates in the acid test are too high.

### Comparative Examples 134-241

Comparative examples 134-241 are the examples listed in WO2013130695 in Table 1, numbers 1-99 and in Table 2, numbers 1-9. The boron content in the glasses from Table 1, numbers 1-99 is too high. The same applies for the glasses from Table 2, numbers 1 and 3-9. The glass from Table 2, number 2 has the composition:

TABLE 33

| | | 2 |
|---|---|---|
| # | Oxide | Mol % |
| 1. | SiO₂ | 72.09 |
| 2. | TiO₂ | 0 |
| 3. | ZrO₂ | 0.02 |
| 4. | Al₂O₃ | 10.81 |
| 5. | ZnO | 0 |
| 6. | MgO | 5.34 |
| 7. | CaO | 5.84 |
| 8. | SrO | 1.52 |
| 9. | BaO | 4.22 |

The remainder consists of 0.14 mol % SnO2 and 0.02 mol % Fe₂O₃. The conversion to constituent phases reveals that the glass does not belong to the base system provided according to the present invention.

### Comparative examples 242-362

Comparative examples 242-362 are the examples of WO2012103194 identified therein with numbers 1-121. Numbers 1-12, 14-18, 20-25, 28-29, 31-35, 38-50, 54-57, 59-60, 62-67, 70-72, 74-75, 77-81, 83-90, 92, 94-102, 104-105, 107-109, 111, 114-116, 119-121 either have a content of Al₂O₃ which is too high or a content of B₂O₃ which is too high. The other glasses have the compositions:

TABLE 34

| | | 13 | | | | | | | |
|---|---|---|---|---|---|---|---|---|---|
| # | Oxide | Mol % | 19 | 26 | 27 | 30 | 36 | 37 | 51 |
| 1. | SiO₂ | 73.69 | 72.87 | 71.82 | 72.80 | 72.94 | 72.91 | 72.92 | 72.89 |
| 2. | TiO₂ | 0.00 | 0.00 | 0.00 | 0.00 | 0.00 | 0.00 | 0.00 | 0.00 |
| 3. | ZrO₂ | 0.00 | 0.02 | 0.03 | 0.02 | 0.02 | 0.02 | 0.02 | 0.02 |
| 4. | Al₂O₃ | 11.39 | 11.40 | 11.26 | 11.40 | 11.38 | 11.39 | 11.39 | 11.39 |
| 5. | ZnO | 0.00 | 0.00 | 0.00 | 0.00 | 0.00 | 0.00 | 0.00 | 0.00 |
| 6. | MgO | 4.74 | 4.92 | 5.96 | 3.89 | 4.86 | 4.30 | 5.39 | 5.13 |
| 7. | CaO | 5.12 | 5.45 | 5.51 | 5.75 | 5.74 | 5.73 | 5.20 | 5.34 |
| 8. | SrO | 1.32 | 1.68 | 1.03 | 2.83 | 0.92 | 2.08 | 0.88 | 1.14 |
| 9. | BaO | 3.75 | 3.65 | 4.39 | 3.31 | 4.14 | 3.58 | 4.20 | 4.09 |

TABLE 35

| | | 52 | | | | | | | |
|---|---|---|---|---|---|---|---|---|---|
| # | Oxide | Mol % | 53 | 58 | 61 | 68 | 69 | 73 | 76 |
| 1. | SiO₂ | 72.76 | 73.70 | 72.83 | 72.95 | 71.88 | 72.85 | 71.93 | 72.83 |
| 2. | TiO₂ | 0.00 | 0.00 | 0.00 | 0.00 | 0.00 | 0.00 | 0.00 | 0.00 |
| 3. | ZrO₂ | 0.02 | 0.00 | 0.00 | 0.00 | 0.02 | 0.02 | 0.02 | 0.02 |
| 4. | Al₂O₃ | 11.45 | 11.39 | 11.43 | 11.39 | 11.28 | 11.44 | 11.51 | 11.39 |
| 5. | ZnO | 0.00 | 0.00 | 0.00 | 0.00 | 0.00 | 0.00 | 0.00 | 0.00 |
| 6. | MgO | 5.16 | 4.74 | 4.96 | 4.88 | 5.35 | 5.08 | 5.62 | 5.19 |
| 7. | CaO | 4.81 | 5.11 | 5.46 | 5.54 | 5.76 | 5.35 | 5.49 | 5.26 |
| 8. | SrO | 2.22 | 1.32 | 1.50 | 0.93 | 1.52 | 0.63 | 1.44 | 0.04 |
| 9. | BaO | 3.59 | 3.74 | 3.83 | 4.32 | 4.19 | 4.64 | 3.99 | 5.27 |

TABLE 36

| | | | | | | 110 | | | | |
|---|---|---|---|---|---|---|---|---|---|---|
| # | Oxide | 82 | 91 | 93 | 106 | Mol % | 112 | 113 | 117 | 118 |
| 1. | SiO₂ | 72.57 | 72.86 | 71.85 | 71.57 | 72.84 | 72.90 | 72.73 | 72.83 | 71.99 |
| 2. | TiO₂ | 0.00 | 0.00 | 0.00 | 0.00 | 0.00 | 0.00 | 0.00 | 0.00 | 0.00 |
| 3. | ZrO₂ | 0.02 | 0.02 | 0.03 | 0.02 | 0.02 | 0.02 | 0.02 | 0.02 | 0.02 |
| 4. | Al₂O₃ | 11.48 | 11.39 | 11.39 | 11.45 | 11.42 | 11.39 | 11.38 | 11.50 | 11.49 |
| 5. | ZnO | 0.00 | 0.00 | 0.00 | 0.00 | 0.00 | 0.00 | 0.00 | 0.00 | 0.00 |
| 6. | MgO | 5.35 | 5.57 | 5.84 | 6.11 | 4.93 | 4.94 | 5.28 | 4.96 | 5.67 |
| 7. | CaO | 5.31 | 3.87 | 5.49 | 5.45 | 5.55 | 5.47 | 5.08 | 5.40 | 5.47 |
| 8. | SrO | 0.37 | 3.09 | 1.08 | 1.43 | 1.17 | 1.37 | 3.30 | 1.46 | 1.12 |
| 9. | BaO | 4.91 | 3.19 | 4.33 | 3.97 | 4.07 | 3.91 | 2.20 | 3.83 | 4.25 |

The compositions of 13, 53 were standardized to 100%, ignoring 0.12 mol % SnO₂ and 0.01 mol % Fe₂O₃. The compositions of 19, 27, 30, 36, 37, 51, 52, 58, 61, 69, 76, 82, 91, 110, 112-113 were standardized to 100%, ignoring 0.11 mol % SnO₂ and 0.02 mol % Fe₂O₃. The compositions of 26, 103 were standardized to 100%, ignoring 0.11 mol % SnO₂ and 0.05 mol % Fe₂O₃. The compositions of 68, 73, 106 were standardized to 100%, ignoring 0.16 mol % SnO₂ and 0.02 mol % Fe₂O₃. The compositions of 93 were standardized to 100%, ignoring 0.11 mol % SnO₂ and 0.04 mol % Fe₂O₃. The compositions of 117 were standardized to 100%, ignoring 0.15 mol % SnO₂ and 0.02 mol % Fe₂O₃. The compositions of 118 were standardized to 100%, ignoring 0.11 mol % SnO₂ and 0.03 mol % Fe₂O₃. The conversion to constituent phases reveals that numbers 91 and 106 do not belong to the base system provided according to the present invention. For the remaining glasses, the composition in constituent phases is as follows:

TABLE 37

| | | 13 | | | | | | | |
|---|---|---|---|---|---|---|---|---|---|
| # | Constituent phase | Mol % | 19 | 26 | 27 | 30 | 36 | 37 | 51 |
| 1. | Silicon dioxide | 45.02 | 43.29 | 40.67 | 43.66 | 43.46 | 43.67 | 43.16 | 43.23 |
| 2. | Wollastonite | 7.07 | 8.55 | 11.20 | 8.73 | 8.49 | 8.55 | 8.49 | 8.55 |
| 3. | Cordierite | 21.31 | 22.12 | 26.82 | 17.48 | 21.85 | 19.33 | 24.24 | 23.07 |
| 4. | Anorthite | 6.33 | 4.61 | −0.48 | 5.45 | 5.89 | 5.73 | 3.72 | 4.17 |
| 5. | Strontium-feldspar | 5.29 | 6.73 | 4.13 | 11.34 | 3.68 | 8.33 | 3.52 | 4.57 |
| 6. | Celsian | 14.98 | 14.62 | 17.55 | 13.26 | 16.54 | 14.30 | 16.78 | 16.34 |
| 7. | Hardystonite | 0.00 | 0.00 | 0.00 | 0.00 | 0.00 | 0.00 | 0.00 | 0.00 |
| 8. | Titanite | 0.00 | 0.00 | 0.00 | 0.00 | 0.00 | 0.00 | 0.00 | 0.00 |
| 9. | Gittinsite | 0.00 | 0.08 | 0.12 | 0.08 | 0.08 | 0.08 | 0.08 | 0.08 |

TABLE 38

| | | 52 | | | | | | | |
|---|---|---|---|---|---|---|---|---|---|
| # | Constituent phase | Mol % | 53 | 58 | 61 | 68 | 69 | 73 | 76 |
| 1. | Silicon dioxide | 42.95 | 45.02 | 43.17 | 43.45 | 41.09 | 43.17 | 41.05 | 43.08 |
| 2. | Wollastonite | 8.61 | 7.03 | 8.63 | 8.55 | 11.04 | 8.47 | 10.02 | 8.67 |
| 3. | Cordierite | 23.21 | 21.31 | 22.31 | 21.95 | 24.07 | 22.85 | 25.29 | 23.34 |
| 4. | Anorthite | 1.92 | 6.37 | 4.57 | 5.05 | 0.88 | 4.37 | 1.84 | 3.60 |
| 5. | Strontium-feldspar | 8.89 | 5.29 | 6.01 | 3.73 | 6.09 | 2.52 | 5.77 | 0.16 |
| 6. | Celsian | 14.34 | 14.98 | 15.30 | 17.27 | 16.75 | 18.55 | 15.95 | 21.07 |
| 7. | Hardystonite | 0.00 | 0.00 | 0.00 | 0.00 | 0.00 | 0.00 | 0.00 | 0.00 |
| 8. | Titanite | 0.00 | 0.00 | 0.00 | 0.00 | 0.00 | 0.00 | 0.00 | 0.00 |
| 9. | Gittinsite | 0.08 | 0.00 | 0.01 | 0.00 | 0.08 | 0.08 | 0.08 | 0.08 |

TABLE 39

| | Constituent | 82 | | | | | | |
|---|---|---|---|---|---|---|---|---|
| # | phase | Mol % | 93 | 110 | 112 | 113 | 117 | 118 |
| 1. | Silicon dioxide | 42.47 | 40.78 | 43.23 | 43.34 | 42.83 | 43.19 | 41.14 |
| 2. | Wollastonite | 8.87 | 10.64 | 8.53 | 8.53 | 8.91 | 8.25 | 9.99 |
| 3. | Cordierite | 24.06 | 26.27 | 22.17 | 22.21 | 23.75 | 22.31 | 25.51 |
| 4. | Anorthite | 3.40 | 0.56 | 5.05 | 4.73 | 2.40 | 5.01 | 1.80 |
| 5. | Strontium- | 1.48 | 4.33 | 4.69 | 5.49 | 13.22 | 5.85 | 4.49 |
| | feldspar | | | | | | | |
| 6. | Celsian | 19.63 | 17.31 | 16.26 | 15.62 | 8.81 | 15.31 | 16.99 |
| 7. | Hardystonite | 0.00 | 0.00 | 0.00 | 0.00 | 0.00 | 0.00 | 0.00 |
| 8. | Titanite | 0.00 | 0.00 | 0.00 | 0.00 | 0.00 | 0.00 | 0.00 |
| 9. | Gittinsite | 0.08 | 0.12 | 0.08 | 0.08 | 0.08 | 0.08 | 0.08 |

Example 26 has a negative anorthite content, so Example 26 does not belong to the base system provided according to the present invention. Otherwise, Example 76 contains too much celsian.

The calculated properties are:

TABLE 40

| | ISO 695: | DIN 12116: | | |
|---|---|---|---|---|
| Seq. | calculated removal | calculated removal | Calculated | |
| no. | rate/mg/(dm² 3 h) | rate/mg/(dm² 6 h) | CTE/(ppm/K) | pH |
| 13 | 83.92 | 4.29 | 3.60 | |
| 19 | 85.1 | 4.81 | 3.71 | |
| 26 | 86.59 | 5.40 | 3.86 | |
| 27 | 85.78 | 4.67 | 3.71 | |
| 30 | 85.14 | 4.71 | 3.70 | |
| 36 | 85.36 | 4.65 | 3.70 | |
| 37 | 85.09 | 4.83 | 3.70 | |
| 51 | 85.23 | 4.81 | 3.71 | |
| 52 | 85.52 | 5.00 | 3.72 | |
| 53 | 83.93 | 4.30 | 3.60 | |
| 58 | 85.28 | 4.89 | 3.72 | |
| 61 | 85.38 | 4.71 | 3.70 | |
| 68 | 86.76 | 5.28 | 3.85 | |
| 69 | 85.77 | 4.89 | 3.71 | |
| 73 | 86.60 | 5.90 | 3.83 | |
| 76 | 86.18 | 4.82 | 3.72 | |
| 82 | 86.32 | 5.21 | 3.75 | |
| 93 | 86.72 | 5.68 | 3.85 | |
| 110 | 83.92 | 4.29 | 3.60 | |
| 112 | 85.17 | 4.77 | 3.70 | |
| 113 | 84.26 | 4.96 | 3.72 | |
| 117 | 85.36 | 5.03 | 3.71 | |
| 118 | 86.62 | 5.79 | 3.83 | |

The calculated removal rates in the alkaline solution test and the acid test are all too high. No pH calculations were carried out.

### Comparative Examples 363-392

Comparative examples 363-392 are the examples of WO0242233 identified therein as glasses 1-3, 6, 8-15, 54-58, 67-68, 75-77, 81, 94-96, 100, 108-110. Of these, the aluminum contents in glasses 3, 6, 9-15, 54-58, 67-68, 75-77, 81, 94-96, 100, 108-110 are too high. Glasses 1, 2, 8 have the composition:

TABLE 41

| | | 1 | | |
|---|---|---|---|---|
| # | Oxide | Mol % | 2 | 8 |
| 1. | SiO₂ | 64.93 | 68.88 | 70.89 |
| 2. | TiO₂ | 0.00 | 0.00 | 0.00 |
| 3. | ZrO₂ | 0.00 | 0.00 | 0.00 |
| 4. | Al₂O₃ | 9.26 | 10.54 | 11.19 |
| 5. | ZnO | 0.00 | 0.00 | 0.00 |
| 6. | MgO | 0.00 | 0.00 | 0.00 |
| 7. | CaO | 25.81 | 20.58 | 17.92 |
| 8. | SrO | 0.00 | 0.00 | 0.00 |
| 9. | BaO | 0.00 | 0.00 | 0.00 |

The conversion to constituent phases yields:

TABLE 42

| | | 1 | | |
|---|---|---|---|---|
| # | Constituent phase | Mol % | 2 | 8 |
| 1. | Silicon dioxide | 29.86 | 37.76 | 41.78 |
| 2. | Wollastonite | 33.10 | 20.08 | 13.46 |
| 3. | Cordierite | 0.00 | 0.00 | 0.00 |
| 4. | Anorthite | 37.04 | 42.16 | 44.76 |
| 5. | Strontium-feldspar | 0.00 | 0.00 | 0.00 |
| 6. | Celsian | 0.00 | 0.00 | 0.00 |
| 7. | Hardystonite | 0.00 | 0.00 | 0.00 |
| 8. | Titanite | 0.00 | 0.00 | 0.00 |
| 9. | Gittinsite | 0.00 | 0.00 | 0.00 |

Examples 2 and 8 contain too much anorthite.

The calculated properties are:

TABLE 43

| | ISO 695: | DIN 12116: | | |
|---|---|---|---|---|
| Seq. | calculated removal | calculated removal | Calculated | |
| no. | rate/mg/(dm² 3 h) | rate/mg/(dm² 6 h) | CTE/(ppm/K) | pH |
| 1 | 87.31 | 5.02 | 4.78 | |
| 2 | 83.97 | 5.00 | 4.16 | |
| 3 | 82.30 | 4.98 | 3.86 | |

The calculated removal rates in the alkaline solution test and the acid test are all too high. No pH calculations were carried out.

### Comparative Examples 393-408

Comparative examples 393-408 are the examples of WO2015009483 identified therein as glasses 1-5 and C1-C11. The aluminum and boron content in all of them is too high. The high, in some cases very high values measured according to DIN 12116 for the removal rates in the acid test are noteworthy.

### Comparative Examples 409-422

Comparative examples 409-418 are the examples of DE102017102900 identified therein as Examples 1-11 and Comparative examples V1-V4. The removal rate in the acid test is too high for all of them.

### Exemplary Embodiments Provided According to the Present Invention

The following Examples A1-A9 are exemplary embodiments provided according to the present invention.

TABLE 44

| | | A1 | | | | | | | | |
|---|---|---|---|---|---|---|---|---|---|---|
| # | Constituent phase | Mol % | A2 | A3 | A4 | A5 | A6 | A7 | A8 | A9 |
| 1. | Silicon dioxide | 56 | 55.5 | 53.5 | 52.5 | 50 | 47.5 | 42 | 42 | 41 |
| 2. | Wollastonite | 0 | 0 | 0 | 1 | 5 | 12.5 | 23 | 23 | 23 |
| 3. | Cordierite | 0 | 4.5 | 4.5 | 4.5 | 0 | 0 | 0 | 0 | 9 |
| 4. | Anorthite | 0 | 0 | 0 | 0 | 10 | 17.5 | 20 | 20 | 27 |
| 5. | Strontium-feldspar | 20 | 16 | 18 | 18 | 15 | 10 | 10 | 15 | 0 |
| 6. | Celsian | 0 | 0 | 0 | 0 | 0 | 0 | 0 | 0 | 0 |
| 7. | Hardystonite | 20 | 20 | 20 | 20 | 20 | 12.5 | 5 | 0 | 0 |
| 8. | Titanite | 0 | 0 | 0 | 0 | 0 | 0 | 0 | 0 | 0 |
| 9. | Gittinsite | 4 | 4 | 4 | 4 | 0 | 0 | 0 | 0 | 0 |

The calculated properties are:

TABLE 45

| | ISO 695: | DIN 12116: | | |
|---|---|---|---|---|
| Seq. | calculated removal | calculated removal | Calculated | |
| no. | rate/mg/(dm² 3 h) | rate/mg/(dm² 6 h) | CTE/(ppm/K) | pH |
| A1 | 73.64 | 0.82 | 3.61 | 8.998 |
| A2 | 72.78 | 0.83 | 3.61 | 8.998 |
| A3 | 74.92 | 0.97 | 3.72 | 9.014 |
| A4 | 75.52 | 0.99 | 3.79 | 9.028 |
| A5 | 77.24 | 1.21 | 4.12 | 9.086 |
| A6 | 77.29 | 1.36 | 4.06 | 9.096 |
| A7 | 80.04 | 1.72 | 4.21 | 9.143 |
| A8 | 81.54 | 2.21 | 4.02 | 9.112 |
| A9 | 78.43 | 2.29 | 4.004 | 9.112 |

Compared with the prior art as presented in detail previously, the glasses provided according to the present invention are characterized in terms of their chemical resistance particularly in that with comparable thermal expansion in each case they have both very good resistance to alkaline solutions and acids, and also very good hydrolytic resistance.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass, comprising:
a composition which is characterized by the following constituent phases of the glass:
silicon dioxide 20-80 mol %;
wollastonite 0-40 mol %;
cordierite 0-30 mol %;
anorthite 0-40 mol %;
strontium-feldspar 0-40 mol %;
celsian 0-20 mol %;
hardystonite 0-40 mol %;
titanite 0-10 mol %; and
gittinsite 0-15 mol %, wherein where the composition is specified in mol % relative to oxides, the glass contains less than 11.5 mol % Al₂O₃ and less than 5000 ppm (molar, relative to the oxides) of each of B₂O₃, Li₂O, Na₂O, K₂O, Rb₂O and Cs₂O, wherein a calculated value for the removal rate according to ISO 695 is not more than 81.9 mg/(dm² 3 h) and a calculated value for the removal rate in acid according to DIN12116 is less than 3.5 mg(dm² 6 h).

2. The glass of claim 1, wherein a wollastonite content of the composition is at least 1 mol %.

3. The glass of claim 2, wherein the wollastonite content is at least 5 mol %.

4. The glass of claim 1, wherein a cordierite content of the composition is at least 1 mol %.

5. The glass of claim 1, wherein an anorthite content of the composition is at least 1 mol %.

6. The glass of claim 5, wherein the anorthite content is at least 10 mol %.

7. The glass of claim 1, wherein a strontium-feldspar content of the composition is at least 1 mol %.

8. The glass of claim 3, wherein the strontium-feldspar content is at least 10 mol %.

9. The glass of claim 1, wherein a celsian content of the composition is not more than 15 mol %.

10. The glass of claim 1, wherein a hardystonite content of the composition is at least 1 mol %.

11. The glass of claim 10, wherein the hardystonite content is at least 5 mol %.

12. The glass of claim 1, wherein a content of components present in the glass in addition to the constituent phases does not exceed 3 mol % of the glass.

13. The glass of claim 12, wherein the content of components present in the glass in addition to the constituent phases does not exceed 1 mol % of the glass.

14. The glass of claim 1, wherein the composition is characterized by the following constituent phases of the glass:
silicon dioxide 25-75 mol %;
wollastonite 0-35 mol %;
cordierite 0-25 mol %;
anorthite 0-35 mol %;
strontium-feldspar 1-35 mol %;
celsian 0-17.5 mol %;
hardystonite 1-35 mol %;
titanite 0-7.5 mol %; and
gittinsite 0-10 mol %.

15. The glass of claim 1, wherein the glass has at least one of a removal rate in acid according to DIN 12116 of <3 mg(dm² 6 h), a removal rate according to ISO 695 not exceeding 81.8 mg/(dm² 3 h) or a coefficient of thermal expansion CTE of 3 to 6 ppm/K.

16. The glass of claim 15, wherein the glass has a removal rate in acid according to DIN 12116 of <2 mg(dm² 6 h).

17. The glass of claim 15, wherein the glass has a removal rate according to ISO 695 not exceeding 80 mg/(dm² 3 h).

18. The glass of claim 1, wherein after dissolution of 50 μmol of the glass in neutral water, a pH value of less than 9.15 is obtained.

19. A pharmaceutical receptacle, comprising:
a glass comprising a composition which is characterized by the following constituent phases of the glass:
silicon dioxide 20-80 mol %;
wollastonite 0-40 mol %;
cordierite 0-30 mol %;
anorthite 0-40 mol %;
strontium-feldspar 0-40 mol %;
celsian 0-20 mol %;
hardystonite 0-40 mol %;
titanite 0-10 mol %; and
gittinsite 0-15 mol %, wherein where the composition is specified in mol % relative to oxides, the glass contains less than 11.5 mol % Al₂O₃ and less than 5000 ppm (molar, relative to the oxides) of each of B₂O₃, Li₂O, Na₂O, K₂O, Rb₂O and Cs₂O, wherein a calculated value for the removal rate according to ISO 695 is not more than 81.9 mg/(dm² 3 h) and a calculated value for the removal rate in acid according to DIN12116 is less than 3.5 mg(dm² 6 h).

20. A method for producing a glass, comprising the steps of:
melting glass raw materials to produce a molten glass; and
cooling the molten glass to form the glass, the glass comprising a composition which is characterized by the following constituent phases of the glass:
silicon dioxide 20-80 mol %;
wollastonite 0-40 mol %;
cordierite 0-30 mol %;
anorthite 0-40 mol %;
strontium-feldspar 0-40 mol %;
celsian 0-20 mol %;
hardystonite 0-40 mol %;
titanite 0-10 mol %; and
gittinsite 0-15 mol %, wherein where the composition is specified in mol % relative to oxides, the glass contains less than 11.5 mol % Al₂O₃ and less than 5000 ppm (molar, relative to the oxides) of each of B₂O₃, Li₂O, Na₂O, K₂O, Rb₂O and Cs₂O, wherein a calculated value for the removal rate according to ISO 695 is not more than 81.9 mg/(dm² 3 h) and a calculated value for the removal rate in acid according to DIN12116 is less than 3.5 mg(dm² 6 h).
